(19) United States
(12) Patent Application Publication
(10) Pub. No.: US 2023/0260533 A1
(43) Pub. Date: Aug. 17, 2023

(54) AUTOMATED SEGMENTATION OF DIGITAL PRESENTATION DATA

(71) Applicant: Micah Development LLC, San Jose, CA (US)

(72) Inventor: Richard Farrell, San Jose, CA (US)

(21) Appl. No.: 18/129,977

(22) Filed: Apr. 3, 2023

Related U.S. Application Data
(63) Continuation-in-part of application No. 17/179,083, filed on Feb. 18, 2021, now Pat. No. 11,635,883.
(60) Provisional application No. 62/978,127, filed on Feb. 18, 2020.

(51) Int. Cl. G10L 25/03; G10L 25/27; G10L 25/84; G06F 16/683

(52) U.S. Cl. CPC G10L 25/03; G06F 16/683; G10L 25/27; G10L 25/84

(57) ABSTRACT

Examples related to methods and systems for analyzing presentation digital data, which may include extracting speaker audio data from the audio data of the presentation digital data and analyzing the speaker audio data to identify a characteristic of the speaker audio data, such as tone, frequency, cadence, and volume. Portions of the presentation digital data are then identified based on changes in the characteristic of the speaker audio data. The identified portions of the presentation digital data are automatically tagged based on the characteristic of the speaker audio data. The identified portions of the presentation digital data and associated tags are stored for retrieval. This method provides a way to efficiently analyze presentation digital data and retrieve specific portions of interest based on the characteristic of the speaker audio data.

### PRIORITY

This application is a continuation-in-part of U.S. Pat. Application Serial No. 17/179,083, filed Feb. 18, 2021, which claims the benefit of priority to U.S. Provisional Pat. Application Serial No. 62/978,127, filed Feb. 18, 2020, all of which are incorporated by reference herein in their entirety.

### TECHNICAL FIELD

The subject matter disclosed herein generally relates to the technical field of special-purpose machines that facilitate content linkage, including software-configured computerized variants of such special-purpose machines and improvements to such variants, and to the technologies by which such special purpose machines become improved compared to other special-purpose machines that facilitate content linkage. Specifically, the present disclosure addresses systems and methods to provide a user with content from public sources.

### BACKGROUND

A computing device with a display may, when presenting text to a user, indicate that additional relevant information is available. For example, in the case of hyperlinks, the computing device may present text that is underlined and in a different color to indicate to the user that additional information is available. When the user selects the hyperlinked text, the user is redirected to a new screen containing information relating to the hyperlinked word or phrase. Additionally, related information may be provided to a user when a cursor is placed over a graphical user interface (GUI) element without the element being selected (the so-called “mouse-over” effect) by popping up a window of information that is related to the GUI element.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 is a diagrammatic representation of a networked environment in which the present disclosure may be deployed, in accordance with some examples.

FIG. 2 illustrates an aspect of the subject matter in accordance with some examples.

FIG. 3 illustrates an aspect of the subject matter in accordance with some examples.

FIG. 4 illustrates an aspect of the subject matter in accordance with some examples.

FIG. 5 illustrates an aspect of the subject matter in accordance with some examples.

FIG. 6 illustrates an aspect of the subject matter in accordance with some examples.

FIG. 7 illustrates an aspect of the subject matter in accordance with some examples.

FIG. 8 illustrates a method in accordance with some examples.

FIG. 9 illustrates an aspect of the subject matter in accordance with some examples.

FIG. 10 illustrates a method in accordance with some examples.

FIG. 11 illustrates an aspect of the subject matter in accordance with some examples.

FIG. 12 illustrates an aspect of the subject matter in accordance with some examples.

FIG. 13 illustrates an aspect of the subject matter in accordance with some examples.

FIG. 14 illustrates an aspect of the subject matter in accordance with some examples.

FIG. 15 illustrates training and use of a machine-learning program, according to some example embodiments.

FIG. 16 is a diagrammatic representation of a machine in the form of a computer system within which a set of instructions may be executed for causing the machine to perform any one or more of the methodologies discussed herein, in accordance with some examples.

FIG. 17 is a block diagram showing a software architecture within which examples may be implemented.

### DETAILED DESCRIPTION

Example methods (e.g., algorithms) facilitate content linkage corresponding to primary content (e.g., a reference or authoritative text) presented to a user based on user-selection, and example systems (e.g., special-purpose machines configured by special-purpose software) are configured to facilitate content linkage based on content identified by or provided to a user. For example, the machine may present a text to the device of the user in which specific portions of the text have indicators that provide additional information to the device of the user. Unless explicitly stated otherwise, structures (e.g., structural components, such as modules) are optional and may be combined or subdivided, and operations (e.g., in a procedure, algorithm, or other function) may vary in sequence or be combined or subdivided. In the following description, for purposes of explanation, numerous specific details are set forth to provide a thorough understanding of various example embodiments. It will be evident to one skilled in the art, however, that the present subject matter may be practiced without these specific details.

A machine (e.g., a mobile device or other computing machine) may be specially configured (e.g., by suitable hardware modules, software modules, or a combination of both) to behave or otherwise function as a content linkage indicator. In accordance with the examples of systems and methods described herein, the machine presents a text on a display screen (e.g., controlled by or otherwise in communication with the mobile device). Example methods (e.g., algorithms) facilitate content linkage corresponding to a text presented to a user based on user selection, and example systems (e.g., special-purpose machines configured by special-purpose software) are configured to facilitate content linkage based on a text provided to a user. For example, the machine may present a text to the device of the user in which specific portions of the text have indicators that provide additional information to the device of the user. Unless explicitly stated otherwise, structures (e.g., structural components, such as modules) are optional and may be combined or subdivided, and operations (e.g., in a procedure, algorithm, or other function) may vary in sequence or be combined or subdivided. In the following description, for purposes of explanation, numerous specific details are set forth to provide a thorough understanding of various example embodiments. It will be evident to one skilled in the art, however, that the present subject matter may be practiced without these specific details.

A machine (e.g., a mobile device or other computing machine) may be specially configured (e.g., by suitable hardware modules, software modules, or a combination of both) to behave or otherwise function as a content linking system or any other component described herein. In accordance with the examples of systems and methods described herein, the machine presents a text on a display screen (e.g., controlled by or otherwise in communication with the mobile device).

### Networked Computing Environment

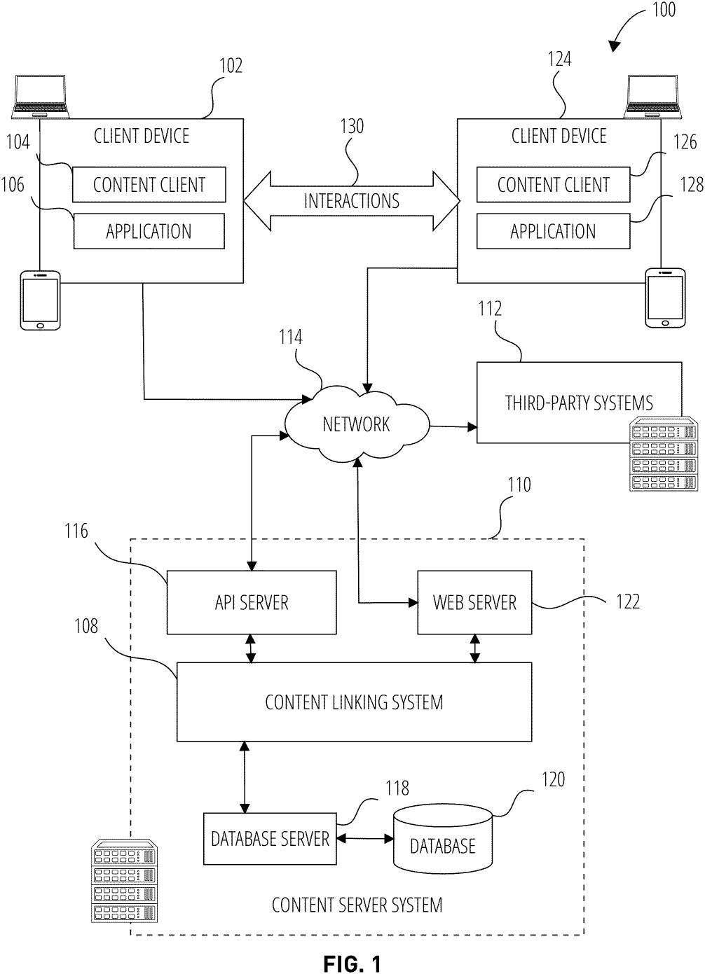

FIG. 1 is a block diagram showing an example content system 100 for facilitating data exchange and transmission (e.g., exchanging text messages, conducting text audio and video calls, or playing games) over a network. The content system 100 includes multiple instances of a client device 102, each of which hosts multiple applications, including a content client 104 and other applications 106. Each content client 104 is communicatively coupled, via a network 114 (e.g., the Internet), to other instances of the content client 104 (e.g., hosted on respective other client devices 102), a content server system 110 and third-party systems 112). A content client 104 can also communicate with locally hosted applications 106 using Applications Program Interfaces (APIs).

A content client 104 interacts with other content clients 104 and with the content server system 110 via the network 114. The data exchanged between content clients 104, and between a content client 104 and the content server system 110, includes functions (e.g., commands to invoke functions) as well as payload data (e.g., text, audio, video or other multimedia data).

The content server system 110 provides server-side functionality via the network 114 to the content clients 104. While certain functions of the content system 100 are described herein as being performed by either a content client 104 or by the content server system 110, the location of certain functionality either within the content client 104 or the content server system 110 may be a design choice. For example, it may be technically preferable to initially deploy certain technology and functionality within the content server system 110 but to later migrate this technology and functionality to the content client 104 where a client device 102 has sufficient processing capacity.

The content server system 110 supports various services and operations that are provided to the content clients 104. Such operations include transmitting data to, receiving data from, and processing data generated by the content clients 104. Data exchanges within the content system 100 are invoked and controlled through functions available via user interfaces (UIs) of the content clients 104.

Turning now specifically to the content server system 110, an Application Program Interface (API) server 116 is coupled to, and provides a programmatic interface to, content linking system 108. The content linking system 108 are communicatively coupled to a database server 118, which facilitates access to a database 120 that stores data associated with contents processed by the content linking system 108. Similarly, a web server 122 is coupled to the content linking system 108 and provides web-based interfaces to the content linking system 108. To this end, the web server 122 processes incoming network requests over the Hypertext Transfer Protocol (HTTP) and several other related protocols.

The Application Program Interface (API) server 116 receives and transmits content data (e.g., commands and message payloads) between the client device 102 and the content linking system 108. Specifically, the Application Program Interface (API) server 116 provides a set of interfaces (e.g., routines and protocols) that can be called or queried by the content client 104 in order to invoke functionality of the content linking system 108. The Application Program Interface (API) server 116 exposes various functions supported by the content linking system 108, including account registration, login functionality, the sending of content data via the content linking system 108, from a particular content client 104 to another content client 104, the communication of content files (e.g., images or video) from a content client 104 to the content linking system 108, the settings of a collection of content data, and the retrieval of messages and content.

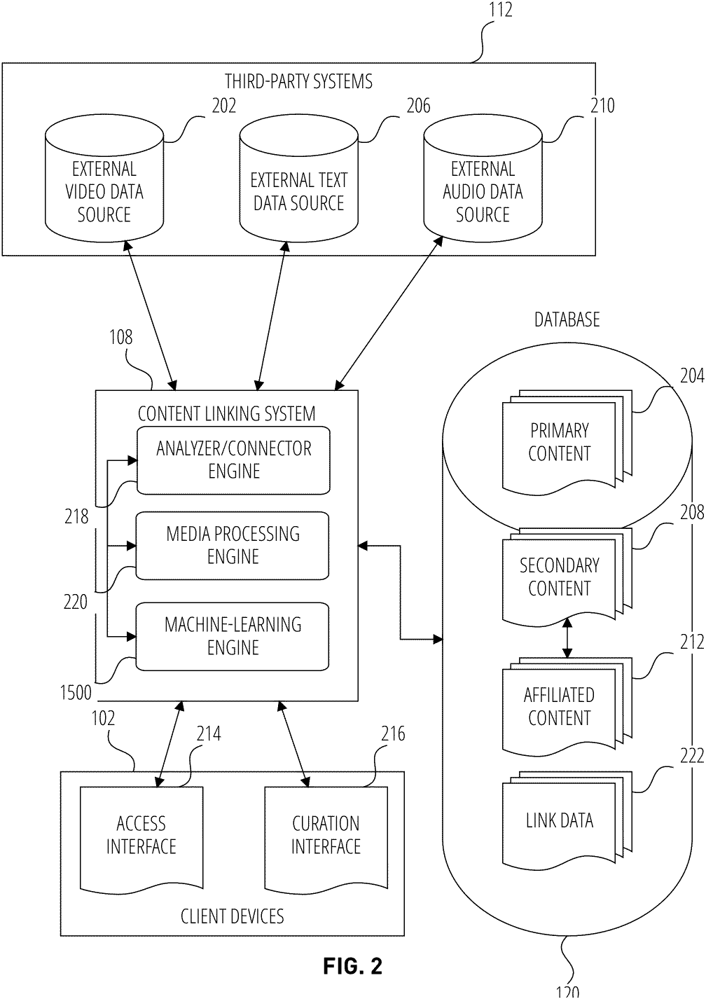

FIG. 2 is an architectural diagram showing further details of the content linking system 108, as well as external data sources that may be accessed by the content linking system 108 for analysis and processing. The content linking system 108 includes three engines, namely and analyzer/connector engine 218, a media processing engine 220, and a machine-learning engine 1500, which are all communicatively coupled via respective interfaces.

The content linking system 108 accesses several external data sources, maintained by third parties as third-party systems 112, via the network 114 and appropriate interfaces (e.g., APIs). These external data sources may contain data and content that is classified by the content linking system 108 as either primary content (e.g., authoritative or reference works, such as religious texts (e.g., the Bible), textbooks or encyclopedias), secondary content (e.g., commentaries related to various authoritative or reference texts), and affiliated content (e.g., content that may have a less direct connection or association with the primary content). The external content may comprise video data, accessible at an external data source 202 (e.g., YouTube), text data accessible at external text data sources 206 (e.g., Wikipedia or various common trees), and audio data accessible at various external data sources 210 (e.g., Spotify, podcast distributors, etc.).

Operationally, the content linking system 108 accesses these various data sources, and, using the analyzer/connector engine 218 in conjunction with the media processing engine 220 and the machine-learning engine 1500, analyzes content to generate metadata relating to this content. Specifically, this metadata may be stored as primary content 204, secondary content 208, and affiliated content 212 within the database 120. The analyzer/connector engine 218 classifies various external bodies of content, for example, as being either primary content, secondary content, or affiliated content, and generate tags, and other data pertaining to this content using predefined rules, or using machine learning implemented by the machine-learning engine 1500. Further, link data is also stored within the database 130, which stores associations between portions of primary content and secondary content and affiliated content.

The media processing engine 220 furthermore downloads licensed, or license-free, content from the third-party systems 112, and perform various editing and curation functions on such authorized copies of the content retrieved from the third-party systems 112.

The content linking system also provides interfaces to client devices 102 so as to enable users to access various information stored within the database 120, and also to access content (e.g., primary, secondary or affiliated content) from the third-party systems 112, or from copied and processed content stored in the database 120. To this end, the content linking system 108 may cause presentation, on the client devices 120 of an access interface 214, further details of which are described herein, so as to allow a user to easily access and navigate data, and also a curation interface 216 so as to enable human oversight and input to analysis processes performed by the analyzer/connector engine 218.

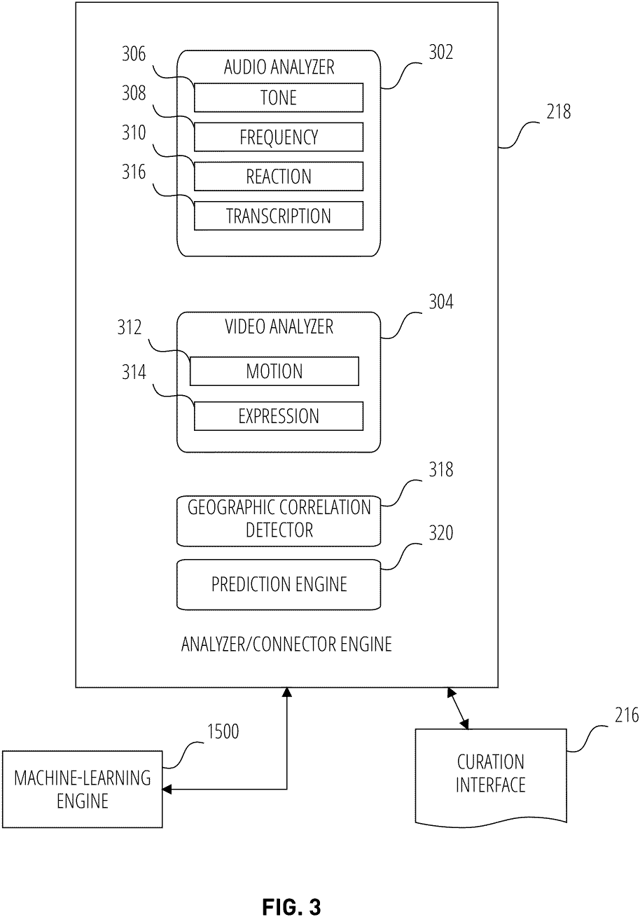

FIG. 3 is an architectural diagram illustrating further architectural details of the analyzer/connector engine 218, according to some examples. The analyzer/connector engine 218 includes an audio analyzer 302 that incorporates various algorithms for inputting and analyzing audio data. The audio data may be pure audio data or audio data extracted from a video file. For example, the analyzer/connector engine 218 may connect to an external video data source 202 (e.g., YouTube), and analyze the audio associated with a particular YouTube video to isolate either a speaker or audience audio data. Speaker audio data is analyzed to detect changes in tone 306 or frequency 308 by the speaker and, based on these changes, to identify portions of the speaker’s presentation that the speaker may want to particularly emphasize or highlight. Subtle changes in tone, volume, cadence, or frequency may furthermore be processed by the machine-learning engine 1500 to also identify portions of the audio from which various inferences can be made, and accordingly, tags generated. For example, where an audio model for a particular speaker is built (e.g., a famous or well-known orator), certain patterns in an audio presentation by the speaker may be identified by a trained machine-learning program 1510 as signaling key points based on previous training data 1504 for that particular speaker and that has been used as input to the machine-learning engine 1500. For a particular speaker, various features 1502 may be identified, and a model constructed for use by the machine-learning engine 1500.

Identifying subtle changes in tone, volume, cadence, or frequency in audio data may involve the use of machine learning techniques to recognize patterns in the speech of a particular speaker. For example, the machine-learning engine 1500 uses previously recorded data training data 1504 to train a model for a particular speaker, such as a well-known orator.

During training, the machine-learning program 1510 analyzes the previously recorded data and extracts a wide range of features 1502, such as pitch, speaking rate, rhythm, and prosody. These features are used to construct a model of the speaker’s speech style, which is then used to analyze new audio data and identify key points in the speech.

Once the model has been trained, it can be used to identify important or key points, sections or portions in new audio presentations by the speaker. For example, the model may recognize a change in pitch or speaking rate as an indication of an important point in the presentation by the presenter. The machine-learning engine 1500 uses this information to identify the relevant section of the presentation, for example using the timestamps, and also to generate tags for the corresponding sections of the audio, indicating the content of the speech at that point.

To illustrate this approach, consider the example of a political speech by a well-known politician. The machine-learning engine 1500 may use previously recorded speeches by the politician as training data to identify patterns in their speech. During training, the machine-learning program 1510 analyzes the speeches and extracts characteristics or features such as pitch, speaking rate, and rhythm. The resulting model may then be used to identify key points in new speeches by the politician, such as moments of emphasis or key policy points, and identify the sections of portions of the speech during which these key points are being communicated.

Another example of this approach is in the analysis of educational lectures. The machine-learning engine 1500 may be trained on lectures by a particular professor to identify patterns in their speech style. During training, the machine-learning program 151 analyzes the lectures and extracts features such as tone, speaking rate, and rhythm. The resulting model could then be used to identify key points in new lectures by the professor, such as moments of emphasis or key concepts.

The successful implementation of this approach requires careful selection of training data and feature selection to ensure that the resulting model is accurate and effective. It also requires the use of advanced machine learning techniques, such as deep learning algorithms, to analyze the audio data and extract relevant features. The disclosed approach has applications in a wide range of domains, including speech recognition, emotion recognition, and social robotics.

In a similar manner, the audio analyzer 302 identifies and filters audience audio data in order to identify audience reactions to certain presentation content. Loud applause from an audience or verbal feedback to the speaker may be used to identify portions of a presentation that are particularly important, or have some other characteristic (e.g., a key point) that can then be a user to generate a tags, or other metadata, for portions of an overall presentation. Additionally, the audio analyzer 302 may generate transcription of a speaker’s presentation to allow for analysis of speech content

In some examples, the audio analyzer 302 identifies and filters audience audio data to identify audience reactions to certain presentation content. The audio analyzer 302 may operate to analyze audio and video presentations and identify key points and themes that are relevant to users.

The audio analyzer 302, in some examples, employs a range of techniques to identify audience reactions to a presentation. These techniques include analyzing the volume and frequency of applause, as well as verbal feedback (e.g., an “amen”) from the audience to the speaker. The audio analyzer 302 uses this information to identify sections or portions of the presentation that are particularly important or have some other characteristic, such as a key point, which can then be used to generate tags or other metadata for portions of the overall presentation.

To implement this approach, in some examples, the audio analyzer 302 first applies signal processing techniques to the audio data. These techniques include Fourier transforms, Mel-frequency cepstral coefficients, and spectral entropy analysis to extract features such as loudness, pitch, and timbre. These features are then used to train machine learning models to identify audience reactions and key points in the presentation.

Identifying key points in a presentation may include training a model to recognize patterns in the audio data that correspond to changes in the speaker’s vocal characteristics or the audience’s reaction. For example, the model may identify changes in loudness or pitch as indicating an important point in the presentation. Similarly, the model may identify patterns in the applause or verbal feedback that signal an important point.

The audio analyzer 302 may also generate a transcription of the speaker’s presentation, which allows for analysis of the speech content. This transcription can be generated using automatic speech recognition (ASR) techniques, which use natural language processing and machine learning algorithms to convert the audio data into text. The resulting transcription can be used to extract information such as speaker gender, language, and accent, which can be used to refine the audio analysis.

The audio analyzer 302 can use the transcription to analyze the text content of the presentation. Natural language processing techniques, such as tokenization, part-of-speech tagging, and sentiment analysis, can be used to extract information such as the subject matter of the presentation, the speaker’s opinion, and the sentiment of the audience.

To summarize, example approaches involve the use of advanced signal processing techniques, machine learning algorithms, and natural language processing to analyze audio data and identify key points and themes in a presentation. The resulting tags or other metadata can be used to provide users with a summary of the presentation, identify important information, or highlight areas of interest. The proposed approach has wide-ranging applications in a variety of domains, including speech recognition, emotion recognition, and social robotics.

Using the sum of several factors, characteristics, and attributes of an audio file processed by the audio analyzer 302, certain portions of an audio presentation may be identified as being related to a certain topic, or as mentioning an authoritative or reference content (e.g., the Bible), and these portions then tagged by the analyzer/connector engine 218 accordingly. For example, where a preacher mentions a particular portion of Scripture, and changes his or her tone and frequency around the subsequent text, the analyzer/connector engine 218 may tag that specific portion of the audio presentation with keywords identifying pertinent passages of Scripture and also tag that portion as being a key point based on various other attributes observed in and extracted from the audio data.

Some examples identify portions of an audio presentation related to a certain topic by training the machine learning models to recognize certain keywords or phrases related to the topic of interest. For example, the model may be trained to recognize words related to a particular industry, such as “finance” or “healthcare.” Similarly, the model may be trained to recognize certain authoritative or reference content, such as the Bible or other religious texts.

Once the model has been trained, it may be used to analyze new audio data and identify portions of the presentation that are related to the topic of interest or reference content. For example, where a preacher mentions a particular portion of Scripture and changes his or her tone and frequency around the subsequent text, the analyzer/connector engine 218 may tag that specific portion of the audio presentation with keywords identifying pertinent passages of Scripture and also tag that portion as being a key point based on various other attributes observed in and extracted from the audio data.

The analyzer/connector engine 218 also includes a video analyzer 304 that includes algorithms to perform several analytic operations on video data accessed at a third-party systems 112. For example, the video analyzer 304 analyzes video data to identify a speaker within a YouTube video, and then analyzes movement on a stage of that speaker to identify key or important portions of the presentation that the speaker may have intended to emphasize. Here, the machine-learning engine 1500 again assists the video analyzer 304 by constructing a model, including a trained machine-learning program 1510, for a particular speaker and be trained to identify that the speaker characteristically stands up (or performs some other motion) when making a key point or wishing to particularly engage with an audience. The portion of the video where the speaker is then standing may be delimited (e.g., the begin and end timestamps recorded) and tagged as being important based on this analysis of the video. In a similar way, the video analyzer 304 may analyze an expression 314 of a speaker, based on a model of that speaker (or a more generalized model) to identify and delimit key portions of a presentation, and tag or generate other metadata pertaining to those key portions.

In some examples, the video analyzer 304 employs a range of computer vision techniques to identify the speaker in the video. These techniques may include face detection and recognition algorithms, which can be trained to recognize the speaker’s face and distinguish it from other faces in the video. Once the speaker has been identified, the video analyzer 304 can begin to analyze speaker movements on a stage or within a video frame.

To identify key portions of a presentation, machine learning models may be trained to recognize certain patterns in the speaker’s movements on stage. For example, the model may be trained to recognize when the speaker stands up or moves to a particular part of the stage, which may signal that the speaker is making a key point or wishing to particularly engage with the audience. Similarly, the model may be trained to recognize certain facial expressions, such as a smile or a frown, which may indicate that the speaker is emphasizing a particular point.

Once the model has been trained, it can be used to analyze new video data and identify key portions of the presentation. For example, the portion of the video where the speaker is standing may be delimited, and the begin and end timestamps recorded. This portion of the video can then be tagged as being important based on the analysis of the speaker’s movements on stage.

The analyzer/connector engine 218 also includes a geographic correlation detector 318, which operates to analyze content, generated at multiple geographic locations, to determine any trends or cross-pollination of ideas, for example. Using time information, and geographic location information, the geographic correlation detector 318 may identify topic trends (e.g., a number of speeches or sermons are being presented in a geographically broad manner, but pertaining to a common topic), or that a specific topic is being presented with increasing frequency within a particular geographic area. Consider, for example, that many preachers internationally may be broadcasting recorded sermons all dealing with a particular issue, or referencing a common Scripture within a determinable time window. The geographic correlation detector 318 may detect these correlations and surface information (e.g., within the access interface 214 or the curation interface 216) for presentation to an end-user or a curator.

For example, the geographic correlation detector 318 may process time and location information associated with the content. This information may be obtained from various sources, such as geotags or metadata associated with the content. The geographic correlation detector 318 can then use this information to identify trends or patterns in the content.

Example approaches to identifying trends in the content include using machine learning algorithms to cluster the content based on its topic or subject matter. For example, the algorithm may group together speeches or sermons that are all dealing with a particular issue, or referencing a common Scripture. The geographic correlation detector 318 can then analyze the location data associated with each piece of content to identify any geographic trends or patterns.

Once the trends or patterns have been identified, the geographic correlation detector 318 can surface this information to an end-user or a curator. For example, the detector may generate a report that highlights a particular topic that is being presented with increasing frequency within a particular geographic area. This information can be presented to an end-user through an access interface 214 or to a curator through a curation interface 216.

A prediction engine 320, which is a part of the analyzer/connector engine 218, may generate predictive metadata and content pertaining to a particular authoritative text based on inferences from other content generated by that particular author. This may be accomplished through the use of machine learning algorithms, natural language processing techniques, and other advanced data analysis methods.

In some examples, the prediction engine 320 may process the content generated by the particular author, such as videos, blog posts, and podcast interviews. Natural language processing techniques are then used to analyze the content and identify patterns or themes in the author’s commentary on a broad range of Scripture, for example.

Once the patterns or themes have been identified, machine learning algorithms are used to make inferences regarding a further portion of Scripture, even if the author has not generated specific content on that topic. For example, the prediction engine 320 may analyze many of a preacher’s previously generated comments and commentary on a broad range of Scripture, identify content from that preacher that is most similar to a particular portion of Scripture, and then make inferences regarding a further portion of Scripture, even though the preacher may not have generated specific content or commented on that topic.

To achieve accurate and meaningful predictions, the prediction engine 320 uses a variety of data sources and analysis techniques. These may include topic modeling, sentiment analysis, and other natural language processing techniques, as well as the analysis of user behavior, demographic data, and other relevant factors.

The prediction engine 320 may also be used to generate predictive metadata and content for other types of authoritative texts, such as legal documents, academic papers, and historical texts. In each case, the engine uses the same core set of techniques to analyze the text, identify patterns and themes, and make inferences regarding related content.

For example, the prediction engine 320 may be used to generate predictive metadata and content related to a particular legal case based on the analysis of previous cases and legal opinions generated by a particular judge or legal scholar. Similarly, the prediction engine 320 may be used to generate predictive metadata and content related to a particular historical figure based on the analysis of their writings, speeches, and other relevant material.

The prediction engine 320 uses machine learning algorithms, natural language processing techniques, and advanced data analysis methods to generate predictive metadata and content for authoritative texts, such as Scripture, legal documents, academic papers, and historical texts. The prediction engine 320 processes content generated by an author or other authoritative figure, identifies patterns or themes and makes inferences regarding related content that the author has not specifically generated.

Operations that may be performed by the prediction engine 320 include:
Data Collection: The prediction engine 320 collects data related to authoritative texts, including videos, blog posts, podcast interviews, legal cases, academic papers, historical texts, and other relevant content. The data is stored in a database or other data storage system.
Natural Language Processing: The prediction engine 320 uses natural language processing techniques to analyze the content and identify patterns or themes in the author’s commentary. Further, the prediction engine 320 uses topic modeling, sentiment analysis, and other relevant techniques to extract meaningful information from the content.
Machine Learning: The prediction engine 320 uses machine learning algorithms to make inferences regarding related content that the author has not specifically generated. The system identifies content from the author that is most similar to a particular portion of the authoritative text, and then makes inferences regarding a further portion of the text.
User Data Analysis: The prediction engine 320 may also analyze user behavior, demographic data, and other relevant factors to generate accurate and meaningful predictions.
Output Generation: The prediction engine 320 generates predictive metadata and content that can be used to supplement the authoritative text. The output may include summaries, commentaries, and other relevant information.
User Interface: The prediction engine 320 may include a user interface that allows users to interact with the system, input data, and view the generated output. The user interface may be a web application, mobile application, or other relevant interface.

Some example uses cases include:
A preacher generates a video commentary on a portion of Scripture. The system analyzes the video, identifies patterns and themes in the preacher’s commentary, and generates predictive metadata and content for related portions of Scripture that the preacher has not specifically commented on.
A legal scholar writes an academic paper on a particular legal topic. The system analyzes the paper, identifies patterns and themes in the scholar’s commentary, and generates predictive metadata and content for related legal topics that the scholar has not specifically written about.
A historian writes a book on a particular historical figure. The system analyzes the book, identifies patterns and themes in the historian’s writing, and generates predictive metadata and content for related historical topics that the historian has not specifically written about.

In some examples, the prediction engine 320 uses GANs to generate the predictive metadata and content pertaining to a particular authoritative text based on inferences from other content generated by that particular author. GANs can be used to analyze the content generated by the particular author, such as videos, blog posts, and podcast interviews, and identify patterns or themes in the author’s commentary on a broad range of Scripture.

GANs are used, in some examples, to make inferences regarding a further portion of Scripture, even if the author has not generated specific content on that topic. For example, the prediction engine 320 may analyze many of a preacher’s previously generated comments and commentary on a broad range of Scripture, identify content from that preacher that is most similar to a particular portion of Scripture and then use GANs to make inferences regarding a further portion of Scripture, even though the preacher may not have generated specific content or commented on that topic.

To achieve accurate and meaningful predictions, GANs analyze a variety of data sources and analysis techniques. These may include topic modeling, sentiment analysis, and other natural language processing techniques, as well as the analysis of user behavior, demographic data, and other relevant factors.

GANs may also be used to generate predictive metadata and content for other types of authoritative texts, such as legal documents, academic papers, and historical texts. In each case, the prediction engine 320 uses GANs to analyze the text, identify patterns and themes, and make inferences regarding related content. For example, GANs can be used to generate predictive metadata and content related to a particular legal case, based on the analysis of previous cases and legal opinions generated by a particular judge or legal scholar. Similarly, GANs can be used to generate predictive metadata and content related to a particular historical figure, based on the analysis of their writings, speeches, and other relevant material.
In some examples, autoencoders may also be used with or without GANs. Autoencoders are neural networks that learn to compress and then reconstruct data. In the context of the prediction engine 320. an autoencoder is trained on a corpus of authoritative texts, such as a collection of a particular author’s works, and then used to generate compressed representations of that author’s writing style. In such examples, the prediction engine 320 may include the following components:
Data Ingestion and Preprocessing: This component is responsible for ingesting authoritative texts and preprocessing the data to prepare it for analysis by the connector engine 218. This will involve tasks such as cleaning the data, tokenizing the text, and removing stop words and other noise.
Prediction Engine 320: This component is responsible for generating predictive metadata and content related to the authoritative texts. The prediction engine will use a variety of machine learning algorithms and natural language processing techniques, including autoencoders, to identify patterns and themes in the text and make inferences regarding related content.
User Interface: This component provides a user interface that allows users to interact with the system and access the generated predictive metadata and content. The user interface may include features such as a search bar, a content recommendation system, and the ability to filter results by topic or author.

Some examples of how autoencoders may be used to generate predictive metadata and content related to authoritative texts include:
Authoritative Text Compression: An autoencoder is trained on a corpus of a particular author’s works, such as videos, blog posts, and podcast interviews. The autoencoder then generates compressed representations of that author’s writing style, which are used by the prediction engine to identify patterns and themes in the author’s commentary on a broad range of Scripture, for example.
Predictive Content Generation: Once the patterns or themes have been identified, machine learning algorithms are used to make inferences regarding a further portion of Scripture, even if the author has not generated specific content on that topic. For example, the prediction engine 320 may analyze many of a preacher’s previously generated comments and commentary on a broad range of Scripture, identify content from that preacher that is most similar to a particular portion of Scripture, and then make inferences regarding a further portion of Scripture, even though the preacher may not have generated specific content or commented on that topic.
Content Recommendation: The compressed representations generated by the autoencoder are used to recommend related content to users. For example, if a user is reading a particular passage of a religious text and the prediction engine identifies that the author’s writing style in that passage is similar to another author’s style, the connector engine 218 may recommend content by that other author that may be of interest to the user.
User Behavior Analysis: The connector engine 218 analyzes user behavior, demographic data, and other relevant factors to generate predictive metadata and content that is tailored to the individual user. For example, the connector engine 218 could recommend content based on the user’s reading history, or make inferences about the user’s interests based on demographic data.

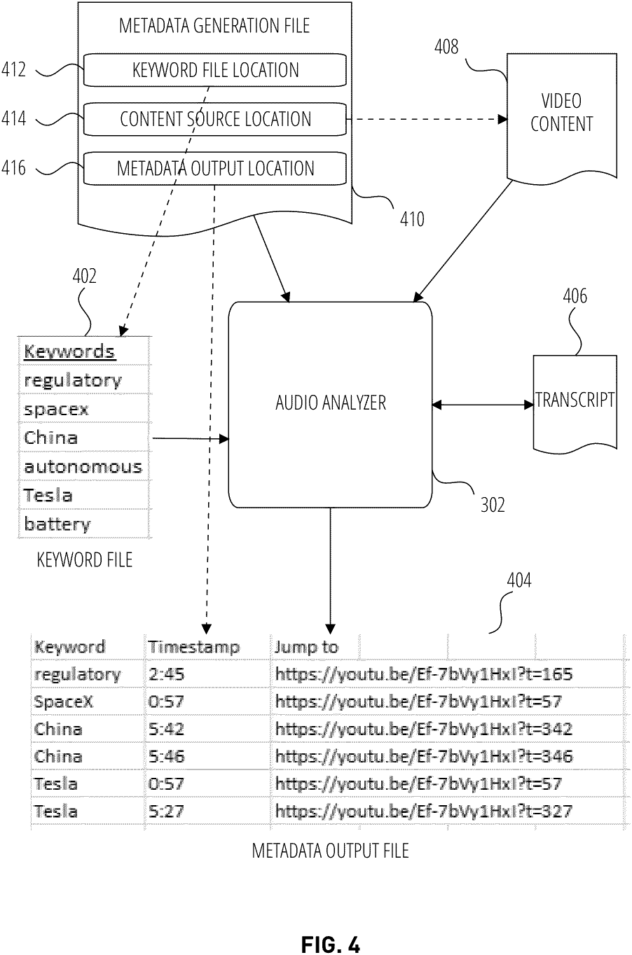

FIG. 4 is a diagrammatic representation of various inputs and outputs for the audio analyzer 302, according to some examples. A metadata generation file 410 is generated based on input received from an end user via the access interface 214 or from a curator via the curation interface 216, and specifies a keyword file location 412 of a keyword file 402. The keyword file 402 includes a number of keywords (e.g., corresponding to topics of interest) that provide input into the audio analyzer 302. The metadata generation file 410 further includes a content source location 414, identifying the location of content (e.g., video content 408) to be analyzed by the audio analyzer 302. Finally, the metadata generation file 410 includes a metadata output location 416 to which the audio analyzer 302 outputs metadata, in the form of a metadata output file 404. The metadata output file 404 embodies the results of the audio analysis performed on the video content 408. Operationally, the metadata generation file 410 is accessed and read by the audio analyzer 302, which then accesses the keyword file 402 to retrieve a list of keywords embodied in that file. In the example shown in FIG. 4, the video content 408 is an interview or presentation presented by Elon musk, the CEO of Tesla Motor Corporation and SpaceX. In this case, the list of keywords embodied in the keyword file 402 identify certain topics of point of interest to be identified within the video content 408. On accessing the video content 408, the audio analyzer 302 generates a transcript 406 of the speaker audio data embodied within the video content 408 (e.g., audio generated and spoken by Elon musk), which is processed and analyzed to identify utterances corresponding to the keywords in the keyword file 402. Based on this analysis, the audio analyzer 302 identifies segments or portions of the video content and associate these segments or portions with one or more of the keywords in the keyword file 402. The metadata output file 404 includes a number of records or line items corresponding to sections or portions of the video content 408, and, for each video segment, records an associated keyword, and a timestamp for a particular portion or segment. The metadata output file 404 is then stored within the database 120 as an example of secondary content 208 and link data 222.

Similar inputs may be provided to the video analyzer 304 for analysis of image data embodied in the video content 408.

Examples of metadata that is generated by the audio analyzer 302 and the video analyzer 304 include style or type categorization data. This style categorization data may be applied to a segment or portion of the video content 408, the entirety of the video content 408 or to a creator featured in, or creator of, the video content 408.

Example systems (e.g., an analyzer/connector engine 218) for the classification of transcribed audio and video data of a talk by a person based on the style of the presenter may deploy a range of techniques and algorithms from the fields of signal processing, natural language processing, and machine learning.

Example systems may use a range of signal processing techniques to extract features from the audio and video data, including Fourier transforms, Mel-frequency cepstral coefficients, and spectral entropy analysis. These features are combined with other features such as pitch, intonation, facial expressions, body language, and gestures extracted using computer vision techniques. For example, facial expressions will be analyzed using a combination of face detection, landmark extraction, and facial expression recognition algorithms.

The extracted features may then be preprocessed using a range of natural language processing techniques. These will include tokenization, part-of-speech tagging, named entity recognition, and sentiment analysis. For example, named entity recognition enables the system to identify and extract concepts, references, names, locations, and organizations mentioned in a transcription of the audio of the video content 408, while sentiment analysis will enable the system to determine the emotional tone of the presenter’s speech.

Once the features have been extracted and preprocessed, example systems may use machine learning algorithms to classify a presentation style of a portion or whole of the video content 408. The algorithms are trained on a labeled dataset of presentations with known styles, and various algorithms are evaluated, including k-nearest neighbors, decision trees, support vector machines, neural networks, and deep learning algorithms. For example, a convolutional neural network may be trained on a large dataset of labeled presentations to classify the style of new presentations.

Example systems may be implemented as a data processing pipeline, which include multiple stages, including data ingestion, feature extraction, feature preprocessing, feature selection, model training, and model evaluation. The pipeline is designed to handle large amounts of audio and video data, and incorporates quality control measures, such as outlier detection, noise reduction, and error handling. For example, the system may incorporate an autoencoder to identify and remove corrupted or noisy data.

The system has a wide range of applications, including speech recognition, emotion recognition, and social robotics. For example, the system may classify the presentation styles of politicians, actors, or public speakers, and used to generate automated summaries or transcripts of their speeches.

Examples of style categorizations that may be generated for a video content 408 featuring a preacher may include, for example:
Discipling / teaching
Fire and brimstone (fiery)
Story telling - stories are the focus sprinkling in Bible passages
Bible-based - the Bible is the focus sprinkling in other stories
Encouraging
Persuading
Theological (seminary pastor)
Liturgical (Anglican churches)
Religious

These style categorizations may then be associated with a portion or whole of the video content 408 or with the relevant preacher.

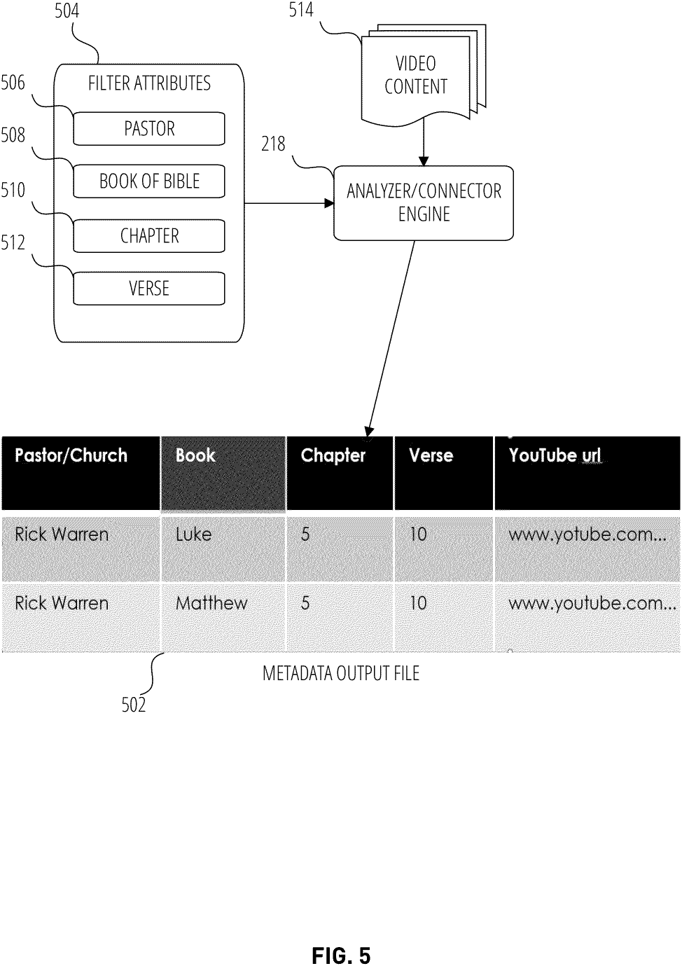

FIG. 5 is a further example showing inputs and outputs to the analyzer/connector engine 218, according to some examples. In the illustrated example, a number of filter attributes 504 and video content 514 provide input to the analyzer/connector engine 218, which then generates a metadata output file 502 based on these inputs. The filter attributes 504 provide input from either an end-user received via the access interface 214 or from a curator received via a curation interface 216, and include identifiers for a particular speaker (e.g., a pastor 506), primary content (e.g., a book of bible 508), as well as primary content portion identifiers (e.g., information, identify a chapter 510 and a verse 512 ). These inputs are then used by the analyzer/connector engine 218 to analyze multiple instances of video content 514 (e.g., multiple sermons and recorded presentations by the pastor, Rick Warren) to identify references by the pastor 506 to the specific portions of the primary content (e.g., to specific chapters and verses of the Christian Bible). Based on this analysis performed by the analyzer/connector engine 218, the metadata output file 502 is generated, the metadata output file 502 identifying a particular pastor, book, chapter and verse, and link to a specific location within a YouTube video at which the relevant chapter and verse of the relevant book of the Christian Bible is mentioned by the pastor. The metadata output file 502 provides an example of secondary content 208 and link data 222 that may be stored by the content linking system 108 within the database 120.

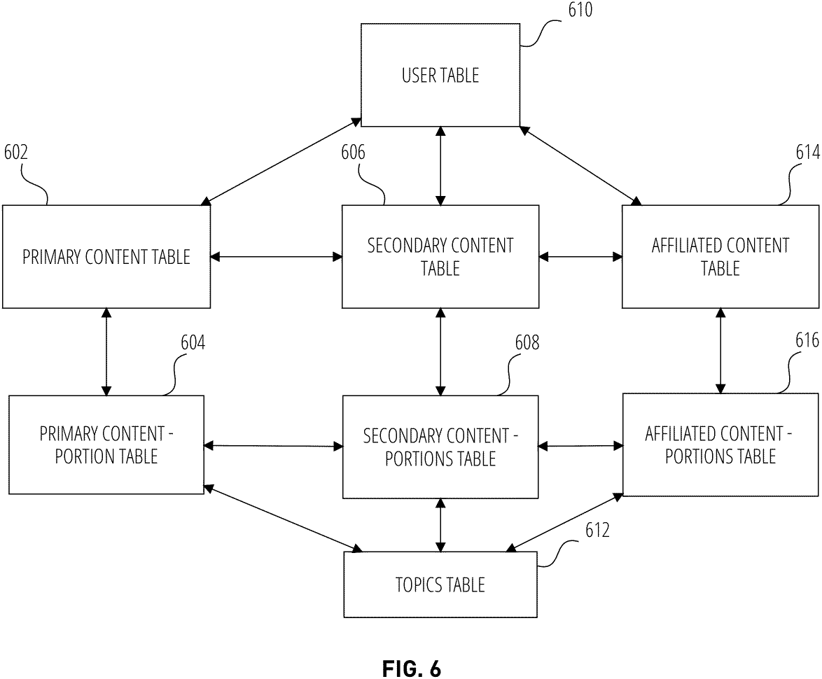

FIG. 6 is a data diagram showing further details of the primary content 204, secondary content 208, and affiliated content 212 stored within the database 120 and various other data types. A user table 610 stores data regarding a particular user and their preferences. For example, the stored user data may include user identifiers, and identification of selected primary content (e.g., reference works), a list of selected sources of secondary content (e.g., a list of preferred authors, commentators, speakers, artists, etc.), and a list of preferred affiliated content (e.g., other sources of information and content). A primary content table 602 stores identification information for various primary content (e.g., authoritative reference works) and metadata pertaining to such primary content. Further, a primary content – portion table 604 contains records for specific portions of primary content (e.g., specific passages or verses within scriptures) and associated metadata for such portions.

A secondary content table 606 stores information pertaining to secondary content, such as a secondary content source or generator (e.g., an author or a preacher), metadata pertaining to specific instances of secondary information from the relevant source (e.g., metadata pertaining to a particular sermon from a preacher), and also links to affiliated content, recorded within the affiliated content table 614. As with primary content, a secondary content - portions table 608 stores information pertaining to particular portions of secondary data, such as the start and end time of a particular segment of a video presentation, as well as metadata pertaining to that segment, including whether the segment was a key point, a reference to Scripture, a repeated topic, etc.

The affiliated content table 614 and affiliated content – portions table 616 stored information pertaining to affiliated content. Primary content, secondary content, and affiliated content may furthermore be organized around certain topics that are stored in a topics table 612. Tags, generated by the analyzer/connector engine 218, are used to organize portions of primary, secondary, and affiliated content around various identified topics.

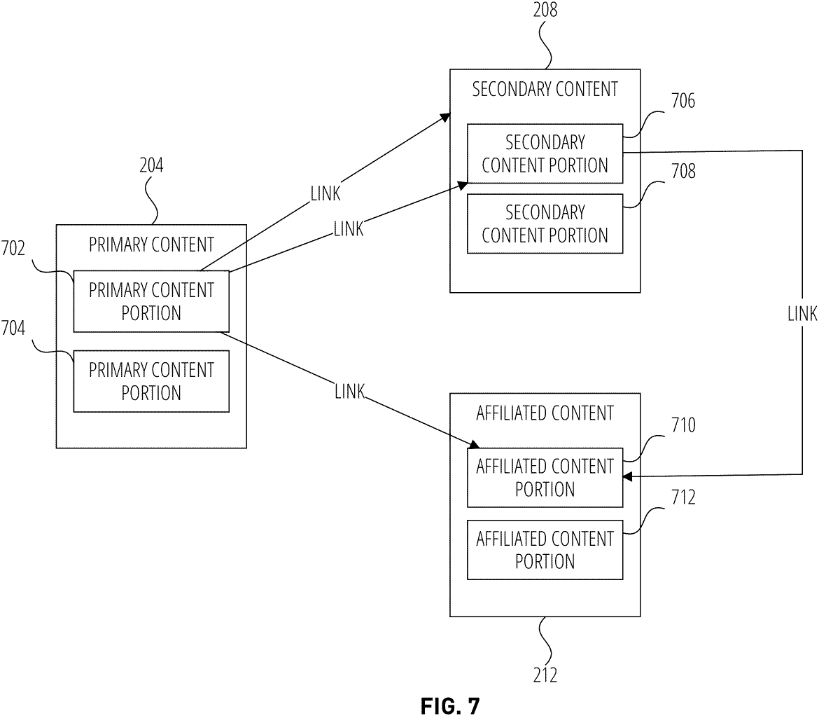

FIG. 7 is a further data diagram illustrating how a particular instance of primary content 204 includes multiple content portions, including primary content portion 702 and primary content portion 704, each of which may be linked to secondary content 208, as well as secondary content portions, such as secondary content portion 706 or secondary content portion 708. Affiliated content 212 is also shown to include content portions, namely affiliated content portion 710 and affiliated content portion 712, which may also be linked using link data to a primary content portion 702.

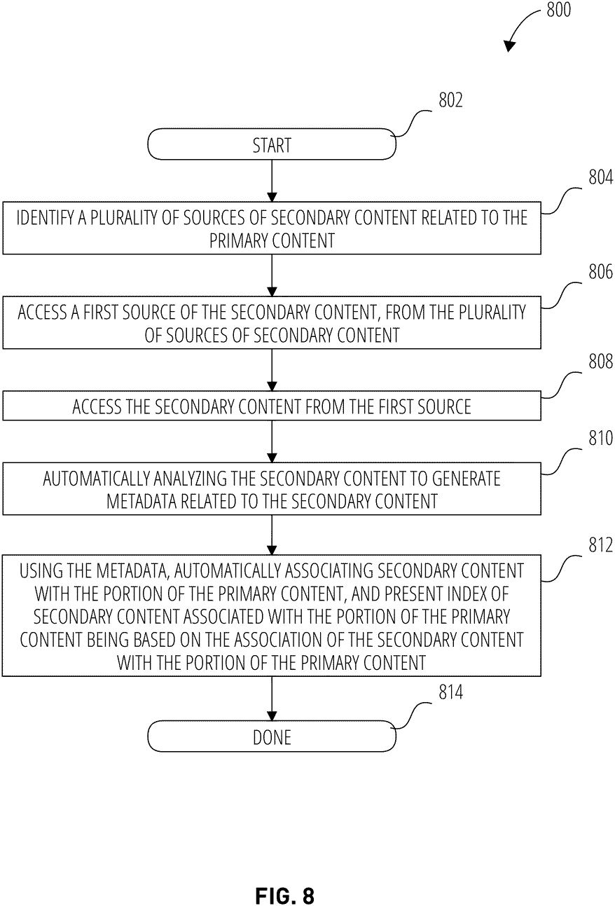

FIG. 8 is a flowchart illustrating a method 800, according to some examples, which may be performed by the content linking system 108, to access, ingest and process source data (e.g., primary content, secondary content, and/or affiliated content) to generate metadata and processed content data to be stored within the database 120.

The method 800 commences at block 802, and proceeds to block 804, where the content linking system 108 identifies several sources of content, including secondary content, related to primary content. For example, where the primary content is the Christian Bible, a number of secondary content sources (e.g., particular authors or publishers of content, as well as platforms on which such authors publish content) may be identified. The identified sources of secondary content related to the Christian Bible may, for example, include a well-known speaker that publishes his or her recorded talks or sermons on YouTube, or blogs or podcasts that are produced by that particular content generator. A curation team associated with the content linking system 108 may be responsible, in some examples, for identifying these sources of secondary content, while in some examples, sources of secondary content may be provided by users of client devices 102 via an access interface 214 of a content client 126. In further examples, the content linking system 108 automatically analyzes particular primary content, and perform an automated survey or search of publicly available data sources on third-party systems 112 to identify many sources (e.g., authors or platforms) related to a specifically identified instance of primary content

At block 806, the content linking system 108 may then access a specific, first source of secondary content (e.g., YouTube) from among the identified sources of secondary content, and then access specific secondary content (e.g., a sermon by a preacher) related to the primary content (e.g., the Christian Bible) from that first source. The access, where permitted, may include downloading and storing a copy of the secondary content at the content linking system 108.

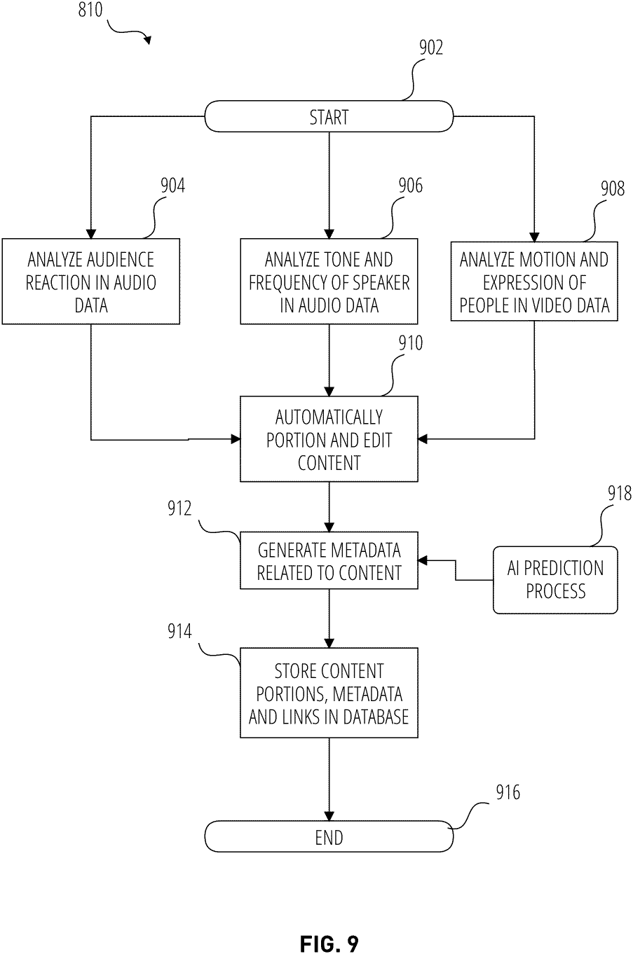

At block 810, the content linking system 108 performs an automatic analysis of the secondary content to generate metadata (e.g., tags, links, delimiters, etc.) related to the secondary content. Further details regarding operations performed during this analysis are described with reference to FIG. 9.

At block 812, the content linking system 108, using the metadata generated at block 810, automatically associates the secondary content with a specific portion of the primary content. For example, a preacher’s sermon relating to a particular verse within the Christian Bible may be associated with that verse within the primary content (e.g., a digital version of the Christian Bible). As will be described in further detail below, an index or list of secondary content associated with the relevant portion of primary content may then be generated and presented to a user, in a manner indicating an association with the portion of primary content, within an access interface 214. The method 800 is then terminates at block 814.

FIG. 9 is a flowchart illustrating further operations of the analysis performed by the content linking system 108 at block 810 of the method 800. Following a start at block 902, and having accessed secondary content (e.g., YouTube video, accessible by the YouTube platform), the audio analyzer 302, video analyzer 304, geographic correlation detector 318, and prediction engine 320 are deployed to perform various functions. Specifically, at block 904, the audio analyzer 302 operates to extract audience audio data from the overall audio data of a presentation video, and performs an analysis of audience audio reactions to identify particular portions of the video in which an audience may have reacted either favorably or unfavorably to a speaker’s presentation. Similarly, at block 906, the audio analyzer 302 identifies and extracts speaker audio from an overall audio data of a presentation, and analyzes the speaker audio data to identify tone, frequency, cadence, volume, and other characteristics to identify portions of the presentation.

At block 908, the video analyzer 304 isolates and identifies motion and expression for presenters within the video data in order to identify and tag certain portions of the overall video presentation based on these detected and observe characteristics of the speaker. As noted above, the machine-learning engine 1500 may be employed within each of block 904, block 906 and block 908 to make inferences regarding a particular portion of the video and audio data. To this end, specific models for a number of sources of secondary data (e.g., public speakers, or authors) may be constructed, and a trained machine-learning program 1510 trained based on a body of previous content generated by that author, in order to generate tags for analyzed content. These tags may, for example, denote a particular portion of a talk (e.g., a TED talk) as being key points, repeated points, or other highlighted portions.

At block 910, based on the analyses performed at block 904, block 906, and or block 908, the content linking system 108 automatically portions or segments the analyzed secondary content. In some examples, the portioning includes flagging segments or portions of a broader body of secondary work. Further, where edit permissions are available, the media processing engine 220 of the content linking system 108 may generate discrete segments of portions of the content for storage within the database 120. For example, considering a particular TED talk having a duration of 20 minutes, based on the analysis, the content linking system 108 may identify key portions of the TED talk, and also identify a main point or topic associated with those key portions. The start and end times, within the context of the total duration of the TED talk, are stored and identified with particular portions. Further, where edit permissions are available, the media processing engine 220 extracts and individually stores relevant portions of the TED talk (e.g., a 30 second segment addressing a particular issue)

At block 912, the analyzer/connector engine 218 of the content linking system 108 operates to generate metadata related to the secondary content, both as a whole, and for the portions of segments identified (and generated). At block 910, an AI prediction process 918, supported by the prediction engine 320 and the machine-learning engine 1500, may be deployed at block 912 to generate predictive or speculative tags or associations for the body of secondary content as a whole, or for specific portions of the secondary content as described above.

At block 914, the content linking system 108 proceeds to store the generated metadata, as well as content portions (e.g., as data, or as identified delimiters), and links within the database 120. This data may be stored in tables for the primary content 204, secondary content 208, affiliated content 212, and as the link data.

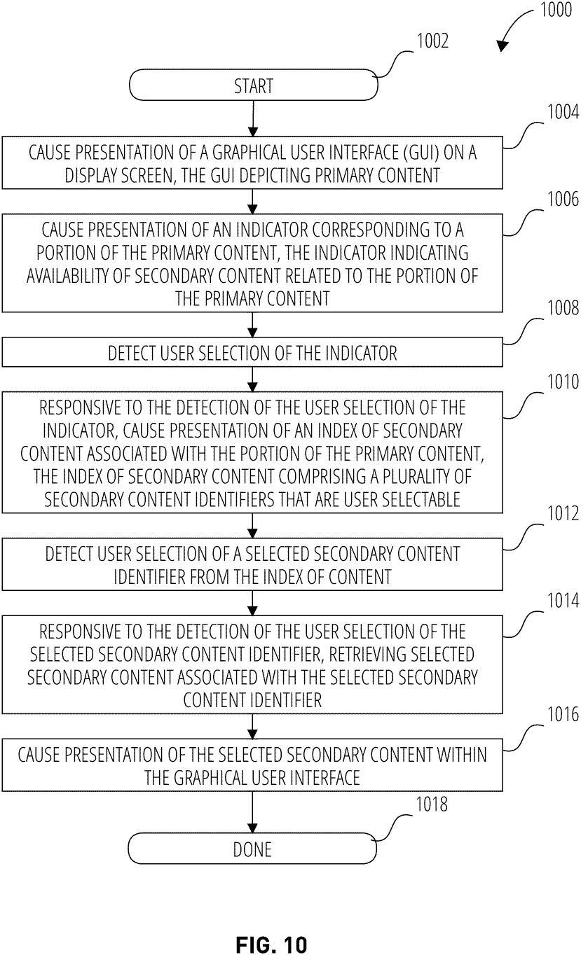

FIG. 10 is a flowchart illustrating a method 1000, according to some examples, to present secondary content (e.g., text, audio or video clips) in association with primary content (e.g., an authoritative or reference work). The method 1000 is computer implemented, in some examples, by the content linking system 108 described above.

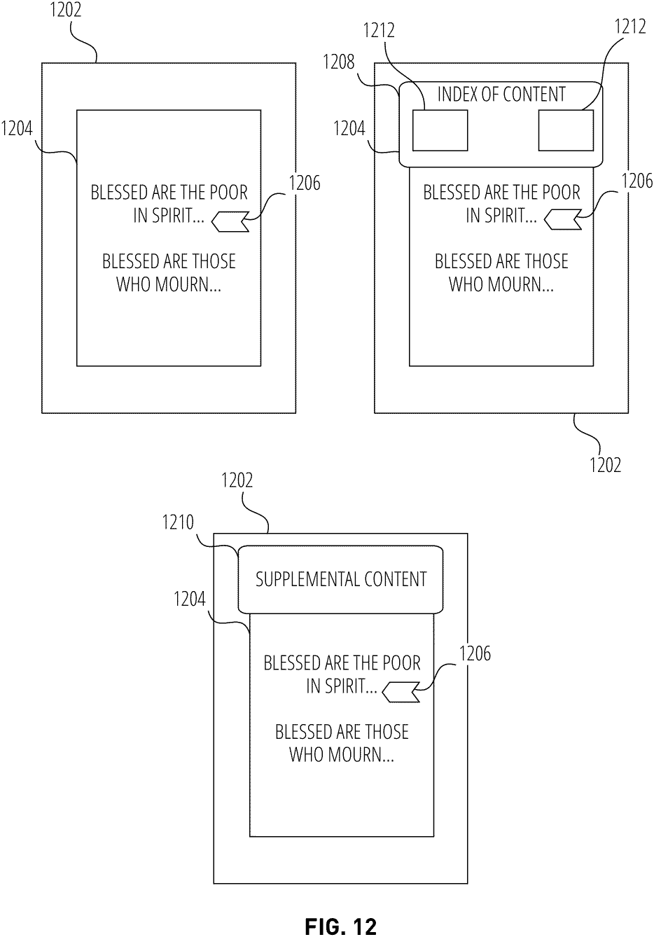

The method 1000 commences at block 1002, and progresses to block 1004, where the content linking system 108 causes presentation of a graphical user interface, in the example form of the access interface 214, on the display screen of a client device 10. The graphical user interface depicts primary content. Referring to FIG. 12, an example is shown in which the primary content may be a body of text 1204 (e.g., certain passages and verses from the Christian Bible).

At block 1006, the content linking system 108 causes the presentation of an indicator (e.g., the indicator 1206 shown in FIG. 12), corresponding to a portion of the primary content (e.g., a verse of the biblical text), the indicator 1206 indicating, to a user, availability of secondary content related to the portion of primary content.

At block 1008, the content linking system 108 detects user selection of the indicator 1206 and, at block 1010, responsive to the detection of the user selection of the indicator, causes the presentation of an index of secondary content (e.g., the index of content 1208 as shown in FIG. 12) that is associated with the portion of the primary contents. The index of secondary content comprises a number of secondary content identifiers 1212 that are user-selectable. Each secondary content identifier 1212 may be associated with a particular source of secondary content, such as a particular author, a particular publisher, a particular platform, or a combination of the above.

At block 1012, the content linking system 108 detects user selection of a selected secondary content identifier 1212 from the index of content 1208, and at block 1012, responsive to the detection of the selection, retrieves selected secondary content, associated with the selected secondary content identifier 1212. Where a secondary content identifier 1212 identifies a source or generator of secondary content (e.g., an author or speaker), the supplemental content 1210 presented at block 1016 may be multiple instances or portions of secondary content, identified with a single larger body of secondary content (e.g., a 2-hour video) from the identified source, or identified with a number of bodies of secondary content (e.g., a number of short video posts on Instagram) from the identified source.

At block 1016, the content linking system 108 causes presentation of the selected secondary content (e.g., supplemental content 1210) within the graphical user interface.

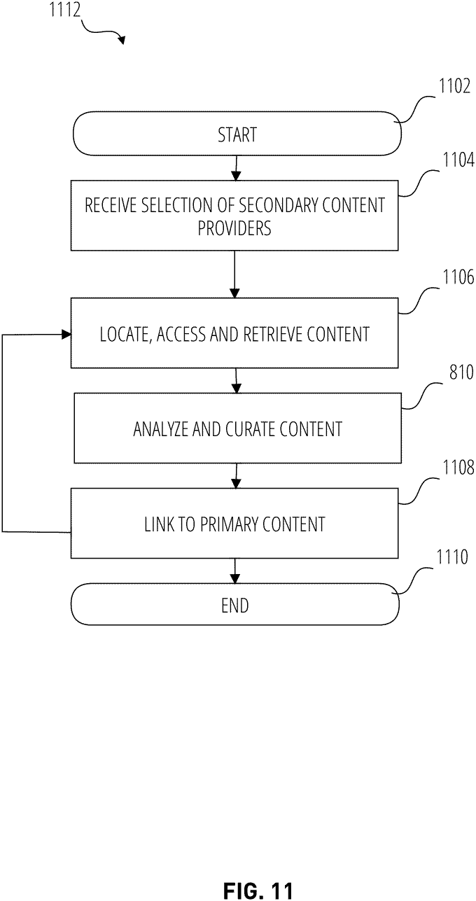

FIG. 11 illustrates an example of a machine-implemented method 1112 for the provision of content by a content system 100. The method 1112 commences at block 1102. A content provider (e.g., from the third-party systems 112) is selected by the content linking system 108, and this selection is received at block 1104. The content comes from various public or private content sources (e.g., external video data source 202, external text data source 206, and external audio data source 210).

The content linking system 108 controls the selection of the content. Users of the content client 126 are able to add related content by uploading related content onto the content linking system 108, or by providing suggestions for new content or content providers. Alternatively, users may be able to vote on particular content that is proposed by the content linking system 108 for inclusion in the database 120 or vote on particular content providers that are proposed for inclusion in the list of available content providers. Similarly, users may be able to rate content or content providers to assist in identifying the best content or content providers.

Next, the content linking system 108 gathers content at block 1106. The content linking system 108 is able to access the content sources selected in block 1106, over the network 114 to retrieve content. The function of the retrieval of content across a network 114 is accomplished through the system processes as shown and described herein. The content gathered may be various types of content. For example, the content may be books, articles, and/or newspapers. Alternatively, or additionally, the content may be sermons and/or live talks. Alternatively, or additionally, the content may be podcasts and/or videos. Alternatively, or additionally, the content may be blogs and/or other online resources. The content can be from any reasonable source associated with the text. The content may be gathered from public sources. Alternatively, or additionally, the content may be gathered from private sources.

Once the content is gathered, it is analyzed at block 810 for specific content by the analyzer/connector engine 218. An algorithm of the analyzer/connector engine 218 is also used to curate the content at block 810. Alternatively, or additionally, the content linking system 108 is programmed to search for relevant content on public sources without a specific content provider being selected.

Finally, the retrieved content is linked, the analyzer/connector engine 218, at block 1108 to an excerpt from the authoritative (or other reference) work and the record of the authoritative work on the system is marked with indicators 1206 to indicate the availability of the retrieved content as a supplement to the excerpt when the excerpt is provided to the user’s device. For example, the content may be linked to scripture.

The content analysis and gathering by the content linking system 108 may be a continuous process in which content is gathered, replaced, and improved as more content becomes available. In one example, the content linking system 108 may connect to audio or video sources and scan the tone of a speaker’s voice in recordings hosted on the audio or video sources, as described herein. For example, in a sermon, the tone of the speech of the pastor may change as the pastor is emphasizing certain points in a sermon. The audio analyzer 302 is configured to identify the changes of tone to identify that what is being spoken about is particularly important, and to perform speech to text recognition on that portion of the sermon. The audio analyzer 302 will thus automatically create a text portion that can be analyzed by the content linking system 108 for potential inclusion as content in the database 120.

In FIG. 12, a graphical user interface 1202 is presented by the content client 104 to a user of a client device 102. The graphical user interface 1202 includes primary content in the example form of a body of text 1204. The body of text 1204 may be from an authoritative work. For example, the body of text 1204 may be a biblical passage. Optionally, the body of text 1204 may be a story. Optionally, the body of text 1204 may be from a book. Optionally, the body of text 1204 may be from a newspaper. The body of text 1204 may comprise of various sentences or phrases or verses. A sentence or phrase may have an indicator 1206 placed next to the end of the phrase or sentence. Additionally, or alternatively, the indicator 1206 may be placed below the phrase or sentence. Additionally, or alternatively, the indicator 1206 may be placed above the phrase or sentence. The indicator 1206 may be a picture or a shape (e.g., cloud or a balloon). Optionally, the indicator 1206 may be colored. The indicator 1206 indicates to the user that further information is available.

As shown in FIG. 12, upon selecting the indicator 1206, an index of content 1208 is displayed overlaid on the graphical user interface 1202. The index of content 1208 includes several secondary content identifiers 1212, each secondary content identifier 1212 being associated with a respective source of secondary content (e.g., an author, speaker, YouTube channel, blog site) or associated with a specific body of secondary content (e.g., a book, treatise or collection of publications).

The index of content 1208 may be a drop-down list of content items. Alternatively, or additionally, the index of content 1208 may be displayed horizontally. The index of content 1208 may be images or words. The index of content 1208 may be displayed over the body of text 1204 without re-directing the user to another screen or site. Alternatively, or additionally, the index of content 1208 may be displayed next to the body of text 1204 without re-directing the user to another screen or site. Alternatively, or additionally, the index of content 1208 may be displayed under or above the body of text 1204 without re-directing the user to another screen or site. The user may be able to simultaneously see the phrase or sentence associated with the indicator 1206 and the index of content 1208 associated with the body of text 1204 as shown by selecting the indicator 1206.

The user has the ability to select, from the index of content 1208 and by selection of secondary content identifiers 1212, a source or an item from one or more of a number of sources (e.g., external video data sources 202, external video data sources 202, or external audio data sources 210), to be displayed via the access interface 214 on the client device 102 of the user. In one example, the user may be able to choose an item represented by a secondary content identifier 1212 from single source of content, to be displayed on graphical user interface 1202. Alternatively, or additionally, the user may be able to choose items, by selecting multiple secondary content identifiers 1212 from multiple sources of content, to be displayed on the graphical user interface 1202. The selection may be by the user touching over the indicator 1206 if the display is a touch screen or by placing a cursor over the indicator 1206 and clicking a button on a mouse or performing some other affirmative selection.

Continuing with FIG. 12, after a secondary content identifier 1212 is selected from the index of content 1208 by the user, secondary content in the example form of supplemental content 1210 relating to a selected secondary content identifier 1212 is displayed to the user by the access interface 214 within the graphical user interface 1202. The supplemental content 1210 may be an image, video, audio, text or combination of these content types. The supplemental content 1210 presented may have additional links to supplemental content (e.g., affiliated content 212), for example a hyper-link may be provided that enables the user to navigate to the supplemental content.

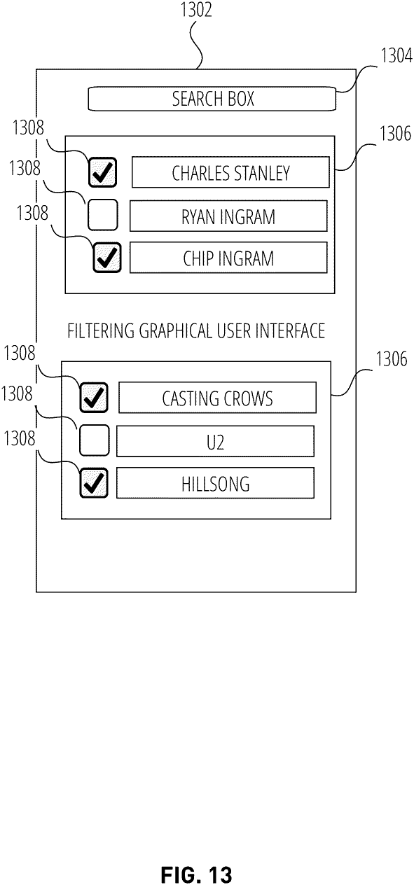

FIG. 13 illustrates examples of a filtering capability associated with a filtering graphical user interface 1302 of the access interface 214 on the client device 102 of a user. The 1302 may be presented within the access interface 214 before the user selects the indicator 1206. Alternatively, the filtering graphical user interface 1302 may be presented after the indicator 1206 is selected and the user is able to view the index of content 1208. In any example, a drop-down list 1306 may be presented to the user in which the user can select filter attributes 1308 relating to the secondary content 208. The user may be able to filter based on content type or the identity of a person, e.g., an author, speaker or composer or other content creator. Alternatively, or additionally, the user may be able to filter based on content medium or type (e.g., text, audio or video). Alternatively, or additionally, the drop-down list 1306 may provide the user with a list of content associated with the primary content 204 in which the user can specify the content desired by selecting the content. Alternatively, or additionally, the user may be able to specify the content desired in a text box. Alternatively, or additionally, the user may have the ability to search in a search box 1304 for a specific piece of content.

In some example, filtering graphical user interface 1302 may also provide filtering capability to filter attributes generated as metadata and stored in the metadata output file 404. For example, the “type” of presenter or content portion may correspond to the style categorization data discussed herein. Accordingly, a user may, using the filter attributes 1308, filter secondary content 208 to include only sources (e.g., specific preachers) or content portions of sermons that are categorized as “encouraging.”

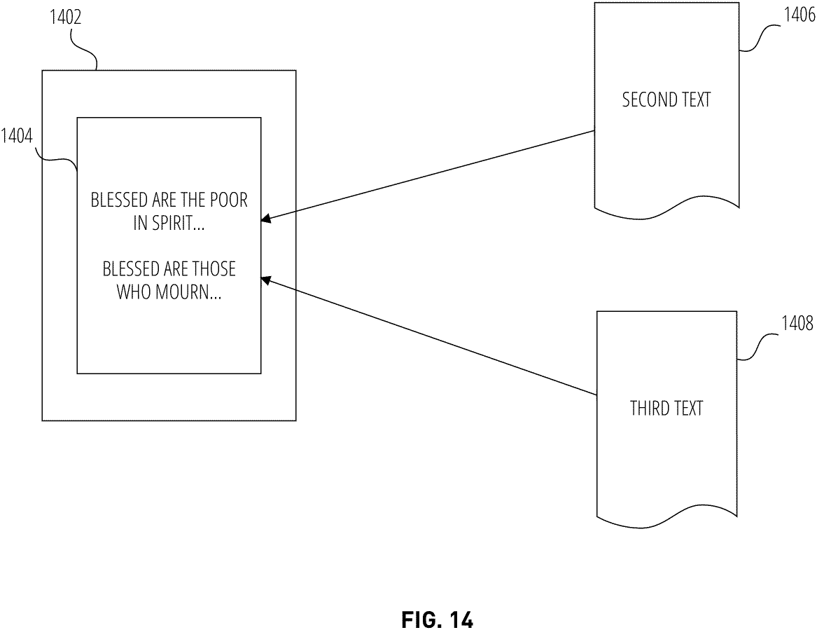

FIG. 14 shows examples of linking content. Retrieved content, e.g., second text 1406, may correspond to the primary text 1404 that will be displayed on the GUI. For example, the second text 1406 may be a text of a sermon relating to a biblical passage that forms the primary text 1404. In another example, the second text 1406 may also be an excerpt from a book, an article, or a newspaper. The content linking system 108 recognizes specific words or phrases in the second text 1406 and find the corresponding word or phrase in an authoritative work or other source of content. For example, if the second text 1406 is a biblical passage, the content linking system 108 recognizes the verses or a citation to a verse (e.g., John 3:16) used in the sermon and pulls up the corresponding biblical passage as primary text 1404, to permit the placement of indicators 1206 on the primary text 1404. The content linking system 108 automatically places indicators 1206 on the primary text 1404 to indicate the availability of secondary content and provide a link to the relevant additional information found in text 1406. The placement of indicators 1206 may then be reviewed by a human curator using the curation interface 216, for example to verify correct placement of indicators 1206 and to check the correctness of the citation or the accuracy of other facts, before the primary text 1404, marked and linked to text 1406, is made available to users as discussed above with reference to FIG. 12.

The retrieved content may include affiliated content 212 in the example form of third text 1408 that is related to the second text 1406, in which the third text 1408 provides more information (e.g., commentary) on the second text 1406. The content linking system 108 is also able to link the third text 1408 to the primary text 1404. For example, the second text 1406 may be the text of the sermon, and the third text 1408 may be the pastor’s notes on the sermon. The third text 1408 may highlight or emphasize certain words or phrases in the primary text 1404. For example, the third text 1408 may include a specific word, which the content linking system 108 recognizes in the primary text 1404. For example, the third text 1408 may expand or focus on a word or phrase expressed in the primary text 1404. The content linking system 108 then automatically place indicators 1206 on the primary text 1404 to indicate the availability of and provide a link to the relevant additional information found in third text 1408. The placement of indicators 1206 may be reviewed by a human curator, for example to verify correct placement of indicators 1206 and to check the correctness of the citation or the accuracy of other facts, before the primary text 1404, marked and linked to second text 1406, is made available to users as discussed above with reference to FIG. 12. The curator may also be able to manually select, highlight, emphasize, and/or link other important information to the text.

### Machine-Learning Engine 1500

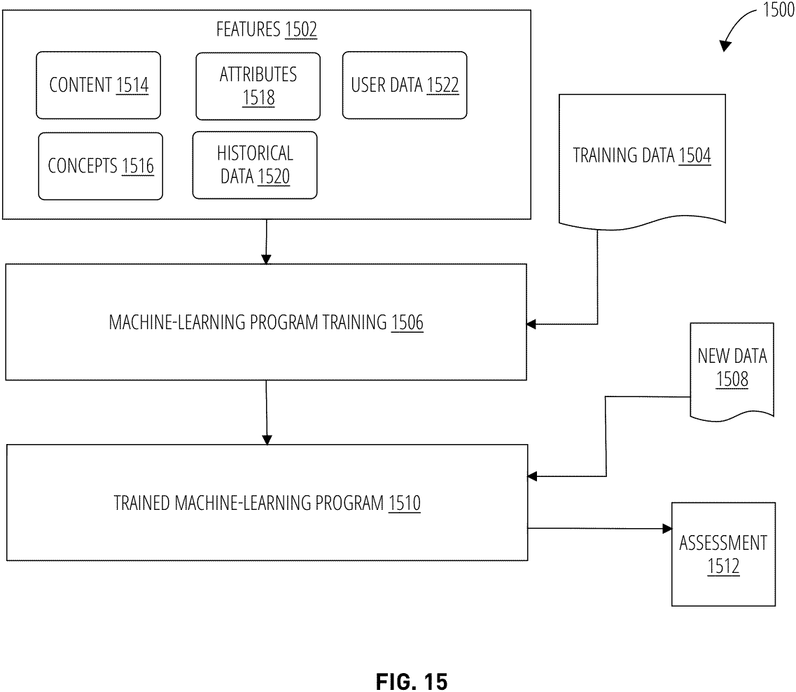

FIG. 15 illustrates training and use of a machine-learning engine 1500, according to some examples, to assist in the content linking operations performed by the content linking system 108. In some examples, machine-learning programs (MLPs), also referred to as machine-learning algorithms or tools, are used to perform operations associated with search, analysis and metadata generation (e.g., tagging) related to primary content 204, secondary content 208 and affiliated content 212.

Machine learning is a field of study that gives computers the ability to learn without being explicitly programmed. Machine learning explores the study and construction of algorithms, also referred to herein as tools, which may learn from existing data and make predictions about new data. Such machine-learning tools operate by building a model from example training data 1504 in order to make data-driven predictions or decisions expressed as outputs or assessments (e.g., assessment 1512). Such assessments 1512 are included in the metadata described herein. Although examples are presented with respect to a few machine-learning tools, the principles presented herein may be applied to other machine-learning tools.

In some example embodiments, different machine-learning tools may be used. For example, Logistic Regression (LR), Naive-Bayes, Random Forest (RF), neural networks (NN), matrix factorization, and Support Vector Machines (SVM) tools may be used for classifying or scoring job postings.

Two common types of problems in machine learning are classification problems and regression problems. Classification problems, also referred to as categorization problems, aim at classifying items into one of several category values (for example, is this object an apple or an orange?). Regression algorithms aim at quantifying some items (for example, by providing a value that is a real number).

The machine-learning algorithms use features 1502 for analyzing the data to generate an assessment 1512. Each of the features 1502 is an individual measurable property of a phenomenon (e.g., extract from the audio or video data) being observed by the analyzer/connector engine 218. The concept of a feature is related to that of an explanatory variable used in statistical techniques such as linear regression. Choosing informative, discriminating, and independent features is important for the effective operation of the MLP in pattern recognition, classification, and regression. Features may be of different types, such as numeric features, strings, and graphs.

In some examples, the features 1502 may be of different types and may include one or more of content 1514, concepts 1516, attributes 1518, historical data 1520 and/or user data 1522, merely for example.

The machine-learning algorithms use the training data 1504 (e.g, for a specific speaker) to find correlations among the identified features 1502 that affect the outcome or assessment 1512. In some examples, the training data 1504 includes labeled data related to secondary content 208, which is known data for one or more identified features 1502 and one or more outcomes, such as detecting communication patterns in secondary content 208, detecting the meaning of a message, generating a summary of secondary content 208e, detecting action items in secondary content 208, detecting urgency in the message, detecting a relationship of the user to an audience, calculating score attributes, calculating message scores, etc.

With the training data 1504 and the identified features 1502, the machine-learning engine 1500 is trained at machine-learning program training 1506. The machine-learning engine 1500 appraises the value of the features 1502 as they correlate to the training data 1504. The result of the training is the trained machine-learning program 1510, for a specific content generator or group of content generators for content stored in the external video data source 202, the external text data source 206, or the external audio data source 210, for example.

When the trained machine-learning program 1510 is used to perform an assessment and to generate metadata, new data 1508 (e.g., fresh second content) is provided as an input to the trained machine-learning program 1510, and the trained machine-learning program 1510 generates the assessment 1512 (e.g., additional metadata) as output.

### Machine Architecture

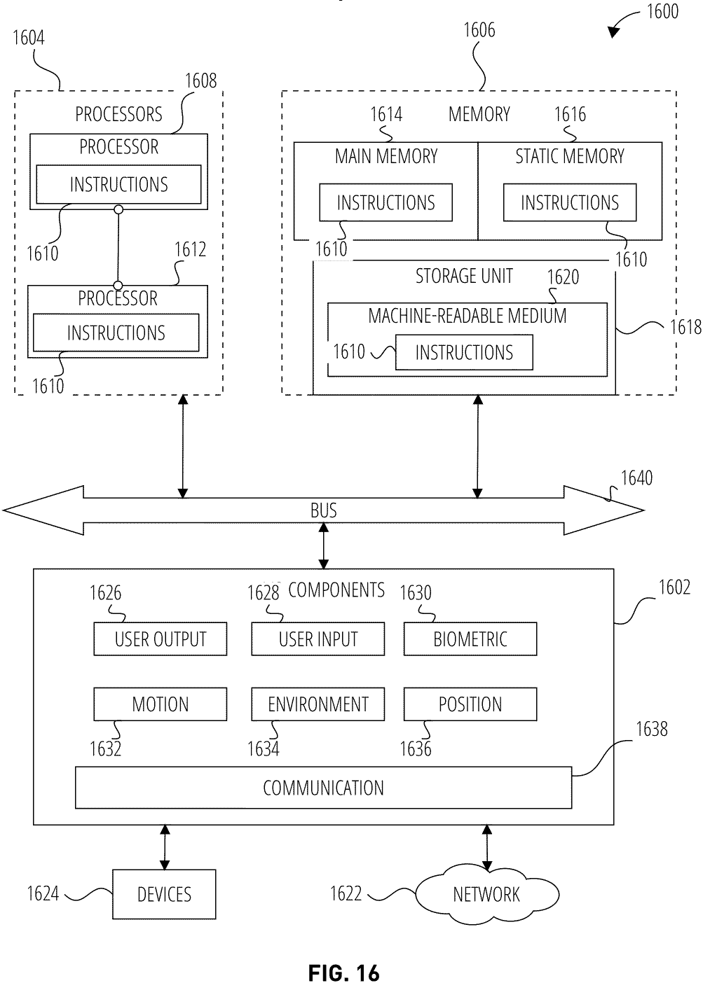

FIG. 16 is a diagrammatic representation of the machine 1600 within which instructions 1610 (e.g., software, a program, an application, an applet, an app, or other executable code) for causing the machine 1600 to perform any one or more of the methodologies discussed herein may be executed. For example, the instructions 1610 may cause the machine 1600 to execute any one or more of the methods described herein. The instructions 1610 transform the general, non-programmed machine 1600 into a particular machine 1600 programmed to carry out the described and illustrated functions in the manner described. The machine 1600 may operate as a standalone device or may be coupled (e.g., networked) to other machines. In a networked deployment, the machine 1600 may operate in the capacity of a server machine or a client machine in a server-client network environment, or as a peer machine in a peer-to-peer (or distributed) network environment. The machine 1600 may comprise, but not be limited to, a server computer, a client computer, a personal computer (PC), a tablet computer, a laptop computer, a netbook, a set-top box (STB), a personal digital assistant (PDA), an entertainment content system, a cellular telephone, a smartphone, a mobile device, a wearable device (e.g., a smartwatch), a smart home device (e.g., a smart appliance), other smart devices, a web appliance, a network router, a network switch, a network bridge, or any machine capable of executing the instructions 1610, sequentially or otherwise, that specify actions to be taken by the machine 1600. Further, while a single machine 1600 is illustrated, the term “machine” shall also be taken to include a collection of machines that individually or jointly execute the instructions 1610 to perform any one or more of the methodologies discussed herein. The machine 1600, for example, may comprise the client device 102 or any one of multiple server devices forming part of the content server system 110. In some examples, the machine 1600 may also comprise both client and server systems, with certain operations of a particular method or algorithm being performed on the server-side and with certain operations of the particular method or algorithm being performed on the client-side.

The machine 1600 may include processors 1604, memory 1606, and input/output I/O components 1602, which may be configured to communicate with each other via a bus 1640. In an example, the processors 1604 (e.g., a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, a processor 1608 and a processor 1612 that execute the instructions 1610. The term “processor” is intended to include multi-core processors that may comprise two or more independent processors (sometimes referred to as “cores”) that may execute instructions contemporaneously. Although FIG. 16 shows multiple processors 1604, the machine 1600 may include a single processor with a single-core, a single processor with multiple cores (e.g., a multi-core processor), multiple processors with a single core, multiple processors with multiples cores, or any combination thereof.

The memory 1606 includes a main memory 1614, a static memory 1616, and a storage unit 1618, both accessible to the processors 1604 via the bus 1640. The main memory 1606, the static memory 1616, and storage unit 1618 store the instructions 1610 embodying any one or more of the methodologies or functions described herein. The instructions 1610 may also reside, completely or partially, within the main memory 1614, within the static memory 1616, within machine-readable medium 1620 within the storage unit 1618, within at least one of the processors 1604 (e.g., within the Processor’s cache memory), or any suitable combination thereof, during execution thereof by the machine 1600.

The I/O components 1602 may include a wide variety of components to receive input, provide output, produce output, transmit information, exchange information, capture measurements, and so on. The specific I/O components 1602 that are included in a particular machine will depend on the type of machine. For example, portable machines such as mobile phones may include a touch input device or other such input mechanisms, while a headless server machine will likely not include such a touch input device. It will be appreciated that the I/O components 1602 may include many other components that are not shown in FIG. 16. In various examples, the I/O components 1602 may include user output components 1626 and user input components 1628. The user output components 1626 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The user input components 1628 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and force of touches or touch gestures, or other tactile input components), audio input components (e.g., a microphone), and the like.

In further examples, the I/O components 1602 may include biometric components 1630, motion components 1632, environmental components 1634, or position components 1636, among a wide array of other components. For example, the biometric components 1630 include components to detect expressions (e.g., hand expressions, facial expressions, vocal expressions, body gestures, or eye-tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 1632 include acceleration sensor components (e.g., accelerometer), gravitation sensor components, rotation sensor components (e.g., gyroscope).

The environmental components 1634 include, for example, one or cameras (with still image/photograph and video capabilities), illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment.

With respect to cameras, the client device 102 may have a camera system comprising, for example, front cameras on a front surface of the client device 102 and rear cameras on a rear surface of the client device 102. The front cameras may, for example, be used to capture still images and video of a user of the client device 102(e.g., “selfies”), which may then be augmented with augmentation data (e.g., filters) described above. The rear cameras may, for example, be used to capture still images and videos in a more traditional camera mode, with these images similarly being augmented with augmentation data. In addition to front and rear cameras, the client device 102 may also include a 360° camera for capturing 360° photographs and videos.

Further, the camera system of the client device 102 may include dual rear cameras (e.g., a primary camera as well as a depth-sensing camera), or even triple, quad or penta rear camera configurations on the front and rear sides of the client device 102. These multiple cameras systems may include a wide camera, an ultra-wide camera, a telephoto camera, a macro camera and a depth sensor, for example.

The position components 1636 include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1602 further include communication components 1638 operable to couple the machine 1600 to a network 1622 or devices 1624 via respective coupling or connections. For example, the communication components 1638 may include a network interface Component or another suitable device to interface with the network 1622. In further examples, the communication components 1638 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 1624 may be another machine or any of a wide variety of peripheral devices (e.g., a peripheral device coupled via a USB).

Moreover, the communication components 1638 may detect identifiers or include components operable to detect identifiers. For example, the communication components 1638 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 1638, such as location via Internet Protocol (IP) geolocation, location via Wi-Fi® signal triangulation, location via detecting an NFC beacon signal that may indicate a particular location, and so forth.

The various memories (e.g., main memory 1614, static memory 1616, and memory of the processors 1604) and storage unit 1618 may store one or more sets of instructions and data structures (e.g., software) embodying or used by any one or more of the methodologies or functions described herein. These instructions (e.g., the instructions 1610), when executed by processors 1604, cause various operations to implement the disclosed examples.

The instructions 1610 may be transmitted or received over the network 1622, using a transmission medium, via a network interface device (e.g., a network interface component included in the communication components 1638) and using any one of several well-known transfer protocols (e.g., hypertext transfer protocol (HTTP)). Similarly, the instructions 1610 may be transmitted or received using a transmission medium via a coupling (e.g., a peer-to-peer coupling) to the devices 1624.

### Software Architecture 1704

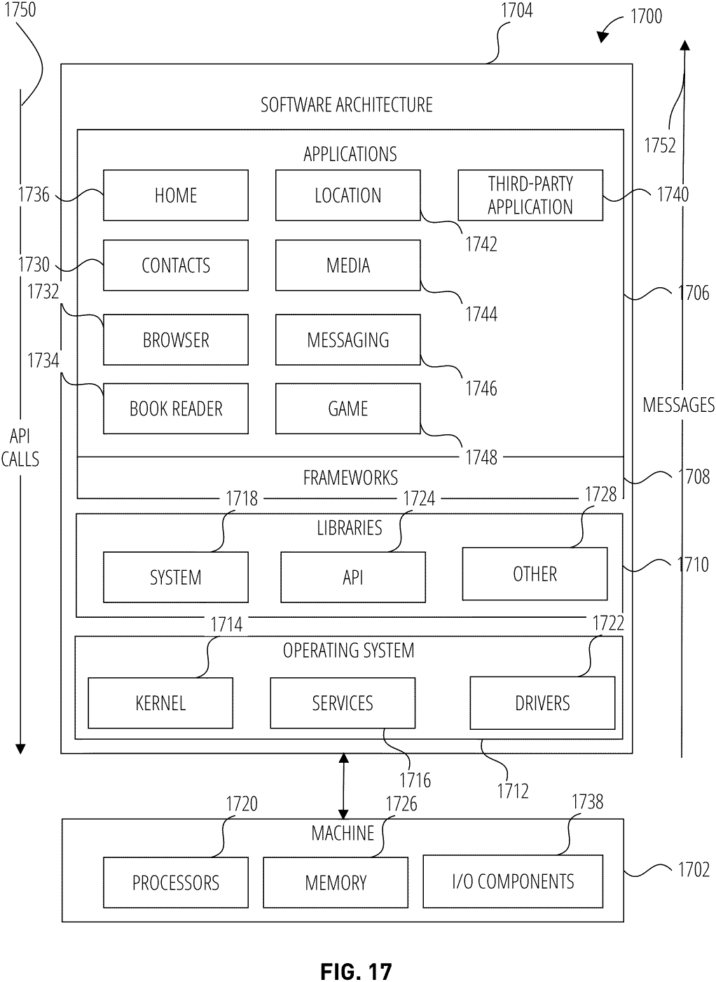

FIG. 17 is a block diagram 1700 illustrating a software architecture 1704, which can be installed on any one or more of the devices described herein. The software architecture 1704 is supported by hardware such as a machine 1702 that includes processors 1720, memory 1726, and I/O components 1738. In this example, the software architecture 1704 can be conceptualized as a stack of layers, where each layer provides a particular functionality. The software architecture 1704 includes layers such as an operating system 1712, libraries 1710, frameworks 1708, and applications 1706. Operationally, the applications 1706 invoke API calls 1750 through the software stack and receive messages 1752 in response to the API calls 1750.

The operating system 1712 manages hardware resources and provides common services. The operating system 1712 includes, for example, a kernel 1714, services 1716, and drivers 1722. The kernel 1714 acts as an abstraction layer between the hardware and the other software layers. For example, the kernel 1714 provides memory management, processor management (e.g., scheduling), component management, networking, and security settings, among other functionalities. The services 1716 can provide other common services for the other software layers. The drivers 1722 are responsible for controlling or interfacing with the underlying hardware. For instance, the drivers 1722 can include display drivers, camera drivers, BLUETOOTH® or BLUETOOTH® Low Energy drivers, flash memory drivers, serial communication drivers (e.g., USB drivers), WI-FI® drivers, audio drivers, power management drivers, and so forth.

The libraries 1710 provide a common low-level infrastructure used by the applications 1706. The libraries 1710 can include system libraries 1718 (e.g., C standard library) that provide functions such as memory allocation functions, string manipulation functions, mathematic functions, and the like. In addition, the libraries 1710 can include API libraries 1724 such as content libraries (e.g., libraries to support presentation and manipulation of various content formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web browsing functionality), and the like. The libraries 1710 can also include a wide variety of other libraries 1728 to provide many other APIs to the applications 1706.

The frameworks 1708 provide a common high-level infrastructure that is used by the applications 1706. For example, the frameworks 1708 provide various graphical user interface (GUI) functions, high-level resource management, and high-level location services. The frameworks 1708 can provide a broad spectrum of other APIs that can be used by the applications 1706, some of which may be specific to a particular operating system or platform.

In some examples, the applications 1706 may include a home application 1736, a contacts application 1730, a browser application 1732, a book reader application 1734, a location application 1742, a media application 1744, a messaging application 1746, a game application 1748, and a broad assortment of other applications such as a third-party application 1740. The applications 1706 are programs that execute functions defined in the programs. Various programming languages can be employed to create one or more of the applications 1706, structured in a variety of manners, such as object-oriented programming languages (e.g., Objective-C, Java, or C++) or procedural programming languages (e.g., C or assembly language). In a specific example, the third-party application 1740 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 1740 can invoke the API calls 1750 provided by the operating system 1712 to facilitate functionality described herein.

### Collaboration and Scripture Interpretation System

Examples of a content collaboration and interpretation system that may be deployed to assist content generation and presentation professionals ((e.g., public speakers, coaches, pastors etc.). Specifically, examples of the system may be deployed to facilitate collaboration between such professionals and also to assist with interpretation of content generated by the professionals. Specific examples are discussed below within the context of a pastoral collaboration and scripture interpretation system. It will be appreciated that examples are not limited to this particular group of professionals and may be deployed any one of a number of professional groups.

Considering pastors as an example of a group of content generation and communication professionals, pastors often struggle with interpreting and teaching Scripture to their congregation, and there is a need for a system that allows them to collaborate and share insights with other pastors. Additionally, there is accordingly a need for a system that can assist pastors in analyzing and interpreting scripture.

Some examples provide a system and methods for pastoral collaboration and scripture interpretation. The content server system 110 includes a database (e.g., database 120) of scripture passages and associated comments (e.g., extracted from audio or video recordings of sermons) from participating pastors. The content server system 110 also includes algorithms for analyzing and interpreting scripture, as well as for identifying matches between pastors based on comments, interpretations, frequency of speech, and body language.

In some examples, pastors can opt-in to the content server system 110 and receive notifications of matching comments and interpretations from other pastors. Pastors can also query the content server system 110 for the most agreed-upon interpretation of a given scripture passage. The content server system 110 can also be integrated with voice assistants such as Alexa, Siri, and Google Home, allowing pastors to ask for specific interpretations from other pastors.

In some examples, pastors can ask the content server system 110 to fill in the gaps in their commentary and provide suggestions for how they may interpret a given scripture based on other similar pastors’ comments.

The content server system 110 includes a database (e.g., database 120) of pastors and associated content (e.g., text, audio, and video data related to publications and sermons/ Metadata, as described above, relating to preaching style, body language, and interpretation of scripture is also stored in the database. This data is collected through video recordings of sermons, speech-to-text algorithms, and machine-learning algorithms designed to analyze body language.

Once the data has been collected, it is stored in a database or data warehouse that can be queried for specific information. A natural language processing (NLP) engine, part of the connector engine 218, may be used to analyze the content of sermons and comments, and to identify similarities in the interpretation of scripture. The NLP engine can also identify patterns in speech frequency and body language. More specifically, NLP may be used to extract meaning from the pastors’ comments and sermons. For example, an NLP technique called Named Entity Recognition (NER) may be deployed to identifying named entities such as people, places, and organizations in a text. NER may use to extract the names of other pastors or churches that a given pastor references in their comments or sermons.

Another NLP technique - sentiment analysis - may be deployed to determine the emotional tone of a text. Sentiment analysis can be used to determine whether a pastor’s comments are positive, negative, or neutral in tone. This information may be used to match pastors who have similar emotional tones in their preaching.

NLP may also be used for text classification, which involves categorizing text into predefined categories. For example, the content server system 110 may categorize a pastor’s comments or sermons as being related to a particular topic or theme, such as forgiveness or salvation. This information could be used to match pastors who have similar interests or preaching styles.

In terms of implementation, the content server system 110 may use a pre-trained NLP model or train its own model on a dataset of pastors’ comments and sermons. The content server system 110 may also use natural language understanding (NLU) tools such as IBM Watson or Google Cloud Natural Language to analyze the text and extract meaningful information. The content server system 110 then uses this information to match pastors based on shared attributes such as topic, sentiment, or named entities.

For the “matchmaking” feature or algorithm, a recommendation engine, which is part of the content linking system 108, analyzes the data on pastors and matches them based on predetermined criteria. This algorithm considers multiple factors, including the number and type of comments, similarity of interpretation of scripture, frequency of speech during sermons, and similarity in body language.

The content server system 110 also allows pastors to ask for a predicted interpretation of a given scripture using a different NLP engine that can process spoken language and extract the relevant information from the request. This feature could be implemented using a voice assistant technology such as Amazon Alexa, Google Assistant, or Apple Siri.

To allow pastors to ask the content server system 110 to “fill in the holes” in their sermon content, a recommendation engine recommends scriptures that have not yet been covered in their sermons. The content server system 110 then predicts the pastor’s interpretation of the scripture based on the interpretations of other pastors in the database. In summary, the content server system 110 may use a combination of NLP algorithms, machine learning algorithms, speech-to-text technology, recommendation engines, and high-performance computing resources.

Further example technical details follow.

System Overview: According to some examples, the content server system 110 is designed to provide pastors with a platform that analyzes their content (e.g., sermons, articles, blog posts or books) and matches them with other pastors based on various factors, including comments on the same Scriptures, similar interpretations of Scriptures, frequency of speech, body language, etc.. The content server system 110 also includes a feature that allows pastors to query the content server system 110 for the most “correct” interpretation of a given Scripture based on consensus, and to use voice assistants like Alexa, SIRI, or Google Home to access information about other pastors’ comments on specific Scriptures.

System Architecture: According to some examples, the content server system 110 consist of several components, including a data storage module or server (e.g., database server 118 and the database 120), a data analysis module (e.g., the analysis/connector engine 218, and an API module (e.g., server 116, see FIG. 1). The data storage module stores pastors’ sermons, comments, and other related data. The data analysis module processes the stored data to generate insights and perform matching operations. The API module will provide an interface for external systems, including voice assistants and other applications, to access the system’s functionality.

Matching Algorithm: According to some examples, a matching algorithm forms part pf the content linking system 108 and operates based on several factors, including comments on the same Scriptures, similar interpretations of Scriptures, frequency of speech, and body language. The algorithm uses a combination of machine learning and rule-based approaches to generate matches between pastors. The matching process is customizable, allowing pastors to adjust the matching criteria based on their specific needs and preferences. The matching algorithm may analyze multiple factors to find the best match. Some of the factors that could be considered include the following:

Comments on the same scriptures: The content server system 110 may analyze the comments made by different pastors on a particular scripture and identify those that share similar interpretations or points of view. The comments are analyzed for various linguistic features, such as key phrases, word usage, and tone, to identify patterns.

Similar interpretations of scriptures: The content server system 110 may compare the interpretation of a particular pastor with the interpretations of other pastors and identify those that share similar views or provide alternative perspectives that could enrich the discussion.

Similar frequency of speech during sermons: The content server system 110 may use audio analysis to compare the frequency and style of speech of different pastors during their sermons. This could include analysis of parameters like pace, tone, rhythm, and use of rhetorical devices.

Similar body language: The content server system 110 uses video analysis to compare the body language of different pastors during their sermons. This includes analysis of parameters like posture, gestures, facial expressions, and eye contact.

To implement this matching algorithm, the content server system 110 uses various machine learning and natural language processing techniques. For example, natural language processing is used to analyze the comments made by pastors and identify key phrases or patterns. Machine learning algorithms are used to learn from the comments made by different pastors and identify similarities and differences in interpretation.

The content server system 110 may also use audio and video analysis tools (e.g., part of the analyzer/connector engine 218) to identify patterns in speech and body language. For example, audio analysis tools are used to identify patterns in pitch, tone, and cadence, while video analysis tools are used to identify patterns in facial expressions and body movements.

In addition, the content server system 110 uses various data integration and aggregation techniques to collect data from different sources, such as online sermons, commentaries, and social media posts, and use this data to enhance the matching algorithm. The content server system 110 also uses natural language processing tools to automatically summarize the comments made by pastors and identify the most important points.

The content server system 110 is integrated with voice assistants like Alexa, SIRI, or Google Home to provide convenient access to the matching algorithm. For example, a pastor can ask the system to provide the most agreed-upon interpretation of a particular scripture or to provide suggestions for how to approach a difficult sermon topic. The content server system 110 then uses the matching algorithm to provide relevant insights and suggestions.

Scripture Analysis: According to some examples, the content server system 110 analyzes pastors’ comments on specific Scriptures and provides a consensus on the most correct/agreed-upon interpretation of the Scripture. This feature uses natural language processing techniques and machine learning algorithms to analyze pastors’ comments and generate a consensus. Pastors can use this feature to ensure that their interpretation of a Scripture aligns with the most commonly accepted interpretation.

Voice Assistant Integration: According to some examples, the content server system 110 is integrated with voice assistants such as Alexa, SIRI, and Google Home, allowing pastors to access information about other pastors’ comments on specific Scriptures using voice commands. Pastors can use this feature to prepare for their sermons, research topics, and get insights from other pastors in their network.

Comment Prediction: According to some examples, the content server system 110 includes a feature that allows pastors to predict what their comments might be on a specific Scripture based on other similar pastors’ comments. This feature uses machine learning algorithms to analyze pastors’ comments and generate a prediction based on the pastor’s style and other relevant factors.

Accordingly, it will be appreciated that the content server system 110 is designed to provide pastors with a powerful tool to enhance their sermons and help them connect with other pastors. The combination of matching algorithms, Scripture analysis, voice assistant integration, and comment prediction enables pastors to improve their sermons and gain insights from other pastors in their network.

Example systems and methods may comprise:
A system for pastoral collaboration and scripture interpretation comprising:
   a database of scripture passages and associated content from participating pastors;
   algorithms for analyzing and interpreting scripture;
   algorithms for identifying matches between pastors based on comments, interpretations, frequency of speech, and body language;
   a notification system for alerting pastors of matching comments and interpretations;
   an interface for querying the system for the most agreed-upon interpretation of a given scripture passage; and
   an integration with voice assistants for requesting specific interpretations from other pastors.
A method for pastoral collaboration and scripture interpretation comprising:
   receiving comments and interpretations of scripture from participating pastors and associating them with the appropriate scripture passage in a database;
   analyzing and interpreting scripture using algorithms to identify patterns and themes among the comments and interpretations;
   identifying matches between pastors based on comments, interpretations, frequency of speech, and body language;
   notifying pastors of matching comments and interpretations;
   providing a user interface for querying the system for the most agreed-upon interpretation of a given scripture passage;
   integrating with voice assistants to allow pastors to request specific interpretations from other pastors; and
   providing suggestions for interpreting scripture based on other similar pastors’ comments.

### EXAMPLES

Example 1 is a method for analyzing digital presentation data comprising: accessing digital presentation data; deploying an analyzer and a segmentation engine to perform various functions; analyzing the digital presentation data to identify a characteristic thereof; performing segmentation of the digital presentation data based on changes in the identified characteristic; generating metadata related to the digital presentation data, both as a whole and for the segmented portions; and storing the generated metadata and segmented portions within a database.

In Example 2, the subject matter of Example 1 includes, wherein the analyzer operates to identify the characteristic using machine-learning models.

In Example 3, the subject matter of Examples 1-2 includes, wherein the characteristic is the sentiment of the speaker.

In Example 4, the subject matter of Examples 1-3 includes, wherein the characteristic is the pace of the speaker.

In Example 5, the subject matter of Examples 1-4 includes, wherein the characteristic is the volume of the speaker.

In Example 6, the subject matter of Examples 1-5 includes, wherein the segmentation engine generates discrete segments of the digital presentation data based on changes in the identified characteristic.

In Example 7, the subject matter of Examples 1-6 includes, wherein the metadata includes information on the author, title, duration, and date of creation of the digital presentation data.

In Example 8, the subject matter of Examples 1-7 includes, wherein the metadata includes information on the identified segments of the digital presentation data.

In Example 9, the subject matter of Examples 1-8 includes, presenting the segmented and analyzed digital presentation data to a user via a user interface.

In Example 10, the subject matter of Examples 1-9 includes, wherein the digital presentation data is a video presentation.

In Example 11, the subject matter of Examples 1-10 includes, wherein the digital presentation data is an audio presentation.

In Example 12, the subject matter of Examples 1-11 includes, wherein the digital presentation data is a combination of video and audio presentations.

In Example 13, the subject matter of Examples 1-12 includes, wherein the analyzer operates to identify the characteristic of the speaker audio using frequency analysis.

In Example 14, the subject matter of Examples 1-13 includes, wherein the analyzer operates to identify the characteristic of the speaker audio using spectral analysis.

In Example 15, the subject matter of Examples 1-14 includes, wherein the analyzer operates to identify the characteristic of the speaker audio using a combination of frequency, spectral, and temporal analyses.

In Example 16, the subject matter of Examples 1-15 includes, wherein the analyzer operates to identify the characteristic of the speaker audio as one or more of tone, pitch, cadence, volume, and other speech characteristics.

In Example 17, the subject matter of Examples 1-16 includes, wherein the analyzer operates to identify the characteristic of the speaker audio as a combination of tone, pitch, cadence, volume, and other speech characteristics.

In Example 18, the subject matter of Examples 1-17 includes, wherein the analyzer operates to identify the characteristic of the audience audio as one or more of applause, laughter, and other audience reactions.

In Example 19, the subject matter of Examples 1-18 includes, wherein the analyzer operates to identify the characteristic of the audience audio by analyzing changes in a noise level of the audience.

In Example 20, the subject matter of Examples 1-19 includes, wherein the analyzer operates to identify the characteristic of the audience audio by analyzing changes in the sentiment of the audience.

In Example 21, the subject matter of Examples 1-20 includes, wherein the analyzer operates to identify the characteristic of the audience audio by analyzing changes in the volume of the audience.

In Example 22, the subject matter of Examples 1-21 includes, wherein the analyzer operates to identify the characteristic of the audience audio by analyzing changes in the tone of the audience.

In Example 23, the subject matter of Examples 1-22 includes, wherein the analyzer operates to identify the characteristic of the video data using image analysis techniques.

In Example 24, the subject matter of Examples 1-23 includes, wherein the analyzer operates to identify the characteristic of the video data as one or more of facial expressions, body language, and other non-verbal cues.

In Example 25, the subject matter of Examples 1-24 includes, wherein the analyzer operates to identify the characteristic of the video data by detecting changes in the presenter’s motion.

In Example 26, the subject matter of Examples 1-25 includes, wherein the analyzer operates to identify the characteristic of the video data by detecting changes in the presenter’s facial expression.

In Example 27, the subject matter of Examples 1-26 includes, wherein the analyzer operates to identify the characteristic of the video data by detecting changes in the presenter’s posture.

In Example 28, the subject matter of Examples 1-27 includes, wherein the analyzer operates to identify the characteristic of the video data as a combination of facial expressions, body language, and other non-verbal cues.

In Example 29, the subject matter of Examples 1-28 includes, wherein the analyzer operates to identify the characteristic of the digital presentation data as a combination of the speaker audio and the video data.

In Example 30, the subject matter of Examples 1-29 includes, wherein the analyzer operates to identify the characteristic of the digital presentation data as a combination of the audience audio and the video data.

In Example 31, the subject matter of Examples 1-30 includes, wherein the analyzer operates to identify the characteristic of the digital presentation data as a combination of the speaker audio, the audience audio, and the video data.

In Example 32, the subject matter of Examples 1-31 includes, wherein the analyzer operates to identify the characteristic of the digital presentation data as a combination of the presenter’s speech characteristics and non-verbal cues.

Example 33 is at least one machine-readable medium including instructions that, when executed by processing circuitry, cause the processing circuitry to perform operations to implement of any of Examples 1-32.

Example 34 is an apparatus comprising means to implement of any of Examples 1-32.

Example 35 is a system to implement of any of Examples 1-32.

Example 36 is a method to implement of any of Examples 1-32.

Example 37 is a method comprising: causing presentation of a graphical user interface (GUI) on a display screen, the GUI depicting primary content; causing presentation of an indicator corresponding to a portion of the primary content, the indicator indicating availability of secondary content related to the portion of the primary content; detecting user selection of the indicator; responsive to the detection of the user selection of the indicator, causing presentation of an index of secondary content associated with the portion of the primary content, the index of secondary content comprising a plurality of secondary content identifiers that are user selectable; detecting user selection of a selected secondary content identifier from the index of content; responsive to the detection of the user selection of the selected secondary content identifier, retrieving selected secondary content associated with the selected secondary content identifier; and causing presentation of the selected secondary content within the graphical user interface.

In Example 38, the subject matter of Example 37 includes, wherein the presenting of the index of secondary content further comprises providing the user with a second index of attributes, the second index corresponding to attributes of the secondary content that are user selectable to filter the plurality of secondary content identifiers of the index of secondary content.

In Example 39, the subject matter of Examples 37-38 includes, wherein the attributes comprise at least one of a person or a group.

In Example 40, the subject matter of Examples 37-39 includes, wherein the attributes comprise a medium of content.

In Example 41, the subject matter of Examples 37-40 includes, wherein the presenting of the selected secondary content further comprises overlaying the selected secondary content over the portion of the primary content, so that the user is operationally able to view both the selected secondary content and the primary content, simultaneously.

In Example 42, the subject matter of Examples 37-41 includes, wherein the presenting of the indicator further comprises presenting the indicator adjacent to the portion of the primary content.

In Example 43, the subject matter of Examples 37-42 includes, wherein the presenting of the index of secondary content comprises causing display of the index of secondary content adj acent to the portion of the primary content.

In Example 44, the subject matter of Examples 37-43 includes, wherein the presenting of the secondary content further comprises presenting a link to affiliated content related to the portion of the primary content, the link being user-selectable to be directed the user to a source of the affiliated content.

In Example 45, the subject matter of Examples 37-44 includes, wherein the plurality of secondary content identifiers identify respective sources of secondary content.

In Example 46, the subject matter of Examples 37-44 wherein the identifying a plurality of sources of secondary content related to the primary content; accessing a first source of the secondary content, from the plurality of sources of secondary content; accessing the secondary content from the first source; automatically analyzing the secondary content to generate metadata related to the secondary content; and using the metadata, automatically associating the secondary content with the portion of the primary content, the presentation of the index of secondary content associated with the portion of the primary content being based on the association of the secondary content with the portion of the primary content

In Example 47, the subject matter of Examples 37-46 includes, wherein the identifying of the plurality of sources of secondary content comprises receiving identification of a source of secondary content from a user, and the automatic association of the secondary content with the portion of the primary content comprises identifying a portion of the secondary content associated with the portion of the primary content using the metadata, and, responsive to the identification of the portion of the secondary content, automatically associating the portion of the secondary content with the portion of the primary content.

In Example 48, the subject matter of Examples 37-47 includes, wherein the secondary content comprises audio data and the analyzing of the secondary content comprises identifying speaker audio data within the audio data, and analyzing the speaker audio data in order to generate the metadata.

In Example 49, the subject matter of Examples 37-48 includes, wherein the analyzing of the speaker audio data comprises automatically generating a textual transcription of the speaker audio data.

In Example 50, the subject matter of Examples 37-49 includes, wherein the analyzing of the speaker audio data comprises automatically detecting changes in at least one of tone or cadence in the speaker audio data, and generating the metadata based on the changes.

In Example 51, the subject matter of Examples 37-50 includes, wherein the secondary content comprises audio data, and the analyzing of the secondary content comprises identifying audience audio data within the audio data, and analyzing the audience audio data in order to generate the metadata.

In Example 52, the subject matter of Examples 37-51 includes, wherein the secondary content comprises video data, and the analyzing of the secondary content comprises analyzing image data of a speaker represented in the video data in order to generate the metadata.

In Example 53, the subject matter of Examples 37-52 includes, wherein the analyzing of the image data of the speaker comprises identifying at least one of a predetermined movement of the speaker or a predetermined facial expression of the speaker.

In Example 54, the subject matter of Examples 37-53 includes, using the metadata, automatically identifying, and tagging portions of the secondary content.

In Example 55, the subject matter of Examples 37-54 includes, using the metadata, automatically editing the secondary content based on the identification of a plurality of portions of the secondary content.

Example 56 is at least one machine-readable medium including instructions that, when executed by processing circuitry, cause the processing circuitry to perform operations to implement of any of Examples 37-55.

Example 57 is an apparatus comprising means to implement of any of Examples 37-55.

Example 58 is a system to implement of any of Examples 37-55.

Example 59 is a method to implement of any of Examples 37-55.

Example 60 is a method to analyze secondary content associated with primary content, the method comprising: accessing the secondary content from a secondary content source; using one or more of an audio analyzer, a video analyzer, a geographic correlation detector, and a prediction engine to analyze the secondary content and identify reference segments of the secondary content; portioning the secondary content into reference segments based on the analysis; generating metadata related to the reference segments of the secondary content; presenting the metadata as filter criteria in conjunction with the primary content in a user interface, to enable a user to filter the presentation of the reference segments of the secondary content within the user interface; and using the prediction engine to generate predictive or speculative tags or associations for the secondary content or the identified discrete segments.

In Example 61, the subject matter of Example 60 includes, wherein the audio analyzer extracts audience audio data from the overall audio data of the secondary content to identify portions in which an audience has reacted either favorably or unfavorably to a speaker’s presentation.

In Example 62, the subject matter of Examples 60-61 includes, wherein the audio analyzer further extracts speaker audio from audio data of the secondary content and analyzes the speaker audio data to identify one or more of tone, frequency, cadence, or volume to identify reference segments of the secondary content.

In Example 63, the subject matter of Examples 60-62 includes, wherein the video analyzer isolates and identifies one or more of motion and expression characteristics of a presenter within video data of the secondary content to identify the reference segments of the secondary content based on the one or more of motion and expression characteristics of a presenter.

In Example 64, the subject matter of Examples 60-63 includes, wherein a machine-learning engine is employed within the audio analyzer, video analyzer, and prediction engine to make inferences regarding a particular reference segment of the secondary content.

In Example 65, the subject matter of Examples 60-64 includes, wherein a specific model for a plurality of sources of secondary data are constructed and a trained machine-learning program is trained based on a body of previous content generated by that author to generate tags for analyzed content.

In Example 66, the subject matter of Examples 60-65 includes, wherein the identified discrete segments of the secondary content are stored in a database.

In Example 67, the subject matter of Examples 60-66 includes, wherein the media processing engine extracts and stores relevant portions of the secondary content.

In Example 68, the subject matter of Examples 60-67 includes, wherein the AI prediction process generates predictive or speculative tags or associations for the identified discrete segments of the secondary content.

In Example 69, the subject matter of Examples 60-68 includes, wherein the AI prediction process generates predictive or speculative tags or associations for the secondary content as a whole.

In Example 70, the subject matter of Examples 60-69 includes, wherein the geographic correlation detector is used to analyze content generated at multiple geographic locations to determine any trends or cross-pollination of ideas.

Example 71 is at least one machine-readable medium including instructions that, when executed by processing circuitry, cause the processing circuitry to perform operations to implement of any of Examples 60-70.

Example 72 is an apparatus comprising means to implement of any of Examples 60-70.

Example 73 is a system to implement of any of Examples 60-70.

Example 74 is a method to implement of any of Examples 60-70.

Example 75 is a method for analyzing speaker audio data in a presentation video, comprising: extracting the speaker audio data from an overall audio data of the presentation video; analyzing the speaker audio data to identify characteristics of the speaker audio data, including at least one of tone, frequency, cadence, and volume of the speaker; identifying portions of the presentation video corresponding to changes in the identified characteristics of the speaker audio data; generating tags for the identified portions of the presentation video based on the identified characteristics of the speaker audio data; and storing the identified portions of the presentation video and associated tags for retrieval and analysis.

In Example 76, the subject matter of Example 75 includes, wherein the speaker audio data is extracted using an audio analyzer.

In Example 77, the subject matter of Examples 75-76 includes, wherein the speaker audio data is analyzed using a machine-learning engine.

In Example 78, the subject matter of Examples 75-77 includes, wherein the machine-learning engine includes a trained machine-learning program that has been trained based on a body of previous content generated by the speaker.

In Example 79, the subject matter of Examples 75-78 includes, wherein the identified characteristics of the speaker audio data are analyzed to identify key or important portions of the presentation video.

In Example 80, the subject matter of Examples 75-79 includes, wherein the generated tags include keywords associated with the identified portions of the presentation video.

In Example 81, the subject matter of Examples 75-80 includes, wherein the identified portions of the presentation video are delimited using timestamps.

In Example 82, the subject matter of Examples 75-81 includes, wherein the identified portions of the presentation video and associated tags are stored in a database.

In Example 83, the subject matter of Examples 75-82 includes, generating a transcript of the speaker audio data to allow for analysis of speech content.

In Example 84, the subject matter of Examples 75-83 includes, wherein the identified portions of the presentation video and associated tags are used to generate a summary of the presentation video.

In Example 85, the subject matter of Examples 75-84 includes, wherein the identified portions of the presentation video and associated tags are used to generate recommendations for related presentation videos.

Example 86 is at least one machine-readable medium including instructions that, when executed by processing circuitry, cause the processing circuitry to perform operations to implement of any of Examples 75-85.

Example 87 is an apparatus comprising means to implement of any of Examples 75-85.

Example 88 is a system to implement of any of Examples 75-85.

Example 89 is a method to implement of any of Examples 75-85.

Example 90 is a content linking system to analyze audience audio data in a presentation video and identifying key portions of the video based on the audience’s reactions, comprising: an audio analyzer to : extract the audience audio data from an overall audio data of a presentation video and perform an analysis of the audience audio data to identify the key portions of the presentation video based on audience reactions inferred from the audience audio data, and a media processing engine to automatically portion or segment the analyzed secondary content based on the identified key portions.

In Example 91, the subject matter of Example 90 includes, a video analyzer configured to isolate and identify characteristics of a presenter within the video data and to identify and tag the key portions of the video presentation based on the characteristics of the presenter.

In Example 92, the subject matter of Examples 90-91 includes, a geographic correlation detector configured to analyze content generated at multiple geographic locations to determine any trends or cross-pollination of ideas, and to identify and tag specific portions of the video presentation based on the correlations.

In Example 93, the subject matter of Examples 90-92 includes a prediction engine that generates predictive metadata and content pertaining to a particular authoritative text, based on inferences from other content generated a particular author.

In Example 94, the subject matter of Examples 90-93 includes, wherein the audio analyzer is further configured to extract speaker audio from overall audio data of a presentation and analyze the speaker audio data to identify audio characteristics to identify key portions of the presentation.

In Example 95, the subject matter of Examples 90-94 includes, wherein the machine-learning engine is employed to make inferences regarding a particular portion of the video and audio data based on specific models for a number of sources of secondary data.

In Example 96, the subject matter of Examples 90-95 includes, wherein the media processing engine generates discrete segments or portions of the content for storage within a database based on the identified key portions.

In Example 97, the subject matter of Examples 90-96 includes, wherein the AI prediction process generates predictive or speculative tags or associations for the body of secondary content as a whole, or for specific portions.

Example 98 is at least one machine-readable medium including instructions that, when executed by processing circuitry, cause the processing circuitry to perform operations to implement of any of Examples 90-97.

Example 99 is an apparatus comprising means to implement of any of Examples 90-97.

Example 100 is a system to implement of any of Examples 90-97.

Example 101 is a method to implement of any of Examples 90-97.

Example 102 is a method for analyzing and segmenting secondary content comprising: accessing secondary content; deploying a video analyzer to isolate and identify motion and expression for presenters within the video data to identify and tag certain portions of the overall video presentation based on the detected and observed characteristics of the speaker; automatically segmenting the analyzed secondary content based on the analyses performed by the video analyzer and generating discrete segments of portions of the content for storage within a database; and generating metadata related to the secondary content, both as a whole, and for the portions of segments identified, using an analyzer/connector engine.

In Example 103, the subject matter of Example 102 includes, extracting audio data of the presentation video, and performing an analysis of audience audio reactions to identify particular portions of the video in which an audience may have reacted favorably or unfavorably to a speaker’s presentation.

In Example 104, the subject matter of Examples 102-103 includes, identifying and extracting speaker audio from an overall audio data of a presentation and analyzing the speaker audio data to identify tone, frequency, cadence, volume, and other characteristics to identify portions of the presentation.

In Example 105, the subject matter of Examples 102-104 includes, identifying geographic location information of the secondary content and analyzing the content to determine topic trends or cross-pollination of ideas across geographic locations.

In Example 106, the subject matter of Examples 102-105 includes, wherein the video analyzer employs a machine-learning engine to make inferences regarding a particular portion of the video data.

In Example 107, the subject matter of Examples 102-106 includes, wherein the metadata generated by the analyzer/connector engine includes tags for analyzed content denoting a particular portion of a talk as being key points, repeated points, or other highlighted portions.

In Example 108, the subject matter of Examples 102-107 includes, wherein an AI prediction process generates predictive or speculative tags or associations for the body of secondary content as a whole or for specific portions of the secondary content.

In Example 109, the subject matter of Examples 102-108 includes, wherein the media processing engine generates relevant portions of the secondary content based on the identified segments.

In Example 110, the subject matter of Examples 102-109 includes, wherein the machine-learning program is trained based on a body of previous content generated by that author to generate tags for analyzed content.

Example 111 is at least one machine-readable medium including instructions that, when executed by processing circuitry, cause the processing circuitry to perform operations to implement of any of Examples 102-110.

Example 112 is an apparatus comprising means to implement of any of Examples 102-110.

Example 113 is a system to implement of any of Examples 102-110.

Example 114 is a method to implement of any of Examples 102-110

### Glossary,

“Client device” refers to any machine that interfaces to a communications network to obtain resources from one or more server systems or other client devices. A client device may be, but is not limited to, a mobile phone, desktop computer, laptop, portable digital assistants (PDAs), smartphones, tablets, ultrabooks, netbooks, laptops, multi-processor systems, microprocessor-based or programmable consumer electronics, game consoles, set-top boxes, or any other communication device that a user may use to access a network.

“Component” refers to a device, physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing certain operations and may be configured or arranged in a certain physical manner. In various examples, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a field-programmable gate array (FPGA) or an application specific integrated circuit (ASIC). A hardware component may also include programmable logic or circuitry that is temporarily configured by software to perform certain operations. For example, a hardware component may include software executed by a general-purpose processor or other programmable processor. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software), may be driven by cost and time considerations. Accordingly, the phrase “hardware component”(or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering examples in which hardware components are temporarily configured (e.g., programmed), each of the hardware components need not be configured or instantiated at any one instance in time. For example, where a hardware component comprises a general-purpose processor configured by software to become a special-purpose processor, the general-purpose processor may be configured as respectively different special-purpose processors (e.g., comprising different hardware components) at different times. Software accordingly configures a particular processor or processors, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In examples in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information). The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors. Similarly, the methods described herein may be at least partially processor-implemented, with a particular processor or processors being an example of hardware. For example, at least some of the operations of a method may be performed by one or more processors 1004 or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API). The performance of certain of the operations may be distributed among the processors, not only residing within a single machine, but deployed across a number of machines. In some examples, the processors or processor-implemented components may be located in a single geographic location (e.g., within a home environment, an office environment, or a server farm). In other examples, the processors or processor-implemented components may be distributed across a number of geographic locations.

List of Drawing Elements

| | |
|---|---|
| 100 | content system |
| 102 | client device |
| 104 | content client |
| 106 | application |
| 108 | content linking system |
| 110 | content server system |
| 112 | third-party systems |
| 114 | network |
| 116 | Application Program Interface (API) server |
| 118 | database server |
| 120 | database |
| 122 | web server |
| 124 | client device |
| 126 | content client |
| 128 | application |
| 130 | interactions |
| 202 | external video data source |
| 204 | primary content |
| 206 | external text data source |
| 208 | secondary content |
| 210 | external audio data source |
| 212 | affiliated content |
| 214 | access interface |
| 216 | curation interface |
| 218 | analyzer/connector engine |
| 220 | media processing engine |
| 222 | link data |
| 302 | audio analyzer |
| 304 | video analyzer |
| 306 | tone |
| 308 | frequency |
| 310 | reaction |
| 312 | motion |
| 314 | expression |
| 316 | transcription |
| 318 | geographic correlation detector |
| 320 | prediction engine |
| 402 | keyword file |
| 404 | metadata output file |
| 406 | transcript |
| 408 | video content |
| 410 | metadata generation file |
| 412 | keyword file location |
| 414 | content source location |
| 416 | metadata output location |
| 502 | metadata output file |
| 504 | filter attributes |
| 506 | pastor |
| 508 | book of bible |
| 510 | chapter |
| 512 | verse |
| 514 | video content |
| 602 | primary content table |
| 604 | primary content - portion table |
| 606 | secondary content table |
| 608 | secondary content - portions table |
| 610 | user table |
| 612 | topics table |
| 614 | affiliated content table |
| 616 | affiliated content - portions table |
| 702 | primary content portion |
| 704 | primary content portion |
| 706 | secondary content portion |
| 708 | secondary content portion |
| 710 | affiliated content portion |
| 712 | affiliated content portion |
| 800 | method |
| 802 | block |
| 804 | block |
| 806 | block |
| 808 | block |
| 810 | block |
| 812 | block |
| 814 | block |
| 902 | block |
| 904 | block |
| 906 | block |
| 908 | block |
| 910 | block |
| 912 | block |
| 914 | block |
| 916 | block |
| 918 | AI prediction process |
| 1000 | method |
| 1002 | block |
| 1004 | block |
| 1006 | block |
| 1008 | block |
| 1010 | block |
| 1012 | block |
| 1014 | block |
| 1016 | block |
| 1018 | block |
| 1102 | block |
| 1104 | block |
| 1106 | block |
| 1108 | block |
| 1110 | done block |
| 1112 | method |
| 1202 | graphical user interface |
| 1204 | body of text |
| 1206 | indicator |
| 1208 | index of content |
| 1210 | supplemental content |
| 1212 | secondary content identifier |
| 1302 | filtering graphical user interface |
| 1304 | search box |
| 1306 | drop-down list |
| 1308 | filter attributes |
| 1402 | graphical user element |
| 1404 | primary text |
| 1406 | second text |
| 1408 | third text |
| 1500 | machine-learning engine |
| 1502 | features |
| 1504 | training data |
| 1506 | machine-learning program training |
| 1508 | new data |
| 1510 | trained machine-learning program |
| 1512 | assessment |
| 1514 | content |
| 1516 | concepts |
| 1518 | attributes |
| 1520 | historical data |
| 1522 | user data |
| 1600 | machine |
| 1602 | I/O components |
| 1604 | processors |
| 1606 | memory |
| 1608 | processor |
| 1610 | instructions |
| 1612 | processor |
| 1614 | main memory |
| 1616 | static memory |
| 1618 | storage unit |
| 1620 | machine-readable medium |
| 1622 | network |
| 1624 | devices |
| 1626 | user output components |
| 1628 | user input components |
| 1630 | biometric components |
| 1632 | motion components |
| 1634 | environmental components |
| 1636 | position components |
| 1638 | communication components |
| 1640 | bus |
| 1700 | block diagram |
| 1702 | machine |
| 1704 | software architecture |
| 1706 | applications |
| 1708 | frameworks |
| 1710 | libraries |
| 1712 | operating system |
| 1714 | kernel |
| 1716 | services |
| 1718 | system libraries |
| 1720 | processors |
| 1722 | drivers |
| 1724 | API libraries |
| 1726 | memory |
| 1728 | other libraries |
| 1730 | contacts application |
| 1732 | browser application |
| 1734 | book reader application |
| 1736 | home application |
| 1738 | I/O components |
| 1740 | third-party application |
| 1742 | location application |
| 1744 | media application |
| 1746 | messaging application |
| 1748 | game application |
| 1750 | API calls |
| 1752 | messages |

What is claimed is:

1. A method comprising:
extracting speaker audio data from audio data of presentation digital data;
analyzing the speaker audio data to identify a characteristic of the speaker audio data, the characteristic including at least one of tone, frequency, cadence, and volume of a speaker;
identifying portions of the presentation digital data based on changes in the characteristic of the speaker audio data;
automatically generating tags for the identified portions of the presentation digital data based on the characteristic of the speaker audio data; and
storing the identified portions of the presentation digital data and associated tags for retrieval.

2. The method of claim 1, wherein the speaker audio data is extracted using an audio analyzer.

3. The method of claim 1, wherein the speaker audio data is analyzed using a machine-learning engine.

4. The method of claim 3, wherein the machine-learning engine includes a trained machine-learning program that has been trained based on a body of previous content generated by the speaker.

5. The method of claim 1, wherein the identified characteristics of the speaker audio data are analyzed to identify key portions of the presentation digital data.

6. The method of claim 1, wherein the generated tags include keywords associated with the identified portions of the presentation digital data.

7. The method of claim 1, wherein the identified portions of the presentation digital data are delimited using timestamps.

8. The method of claim 1, further comprising generating a transcript of the speaker audio data to allow for analysis of speech content.

9. The method of claim 1, wherein the identified portions of the presentation digital data and associated tags are used to generate a summary of the presentation digital data.

10. The method of claim 1, wherein the identified portions of the presentation digital data and associated tags are used to generate recommendations for related presentation digital data.

11. The method of claim 1, comprising causing presentation on a user interface to enable searching of the presentation digital data using the tags.

12. The method of claim 1, comprising:
extracting audience audio data from the audio data of the presentation digital data;
analyzing the audience audio data to identify a characteristic of the audience audio data; and
identifying the portions of the presentation digital data based on changes in the characteristic of the audience audio data.

13. The method of claim 12, wherein the characteristic of the audience audio data comprises at least one of a favorable audience reaction and an unfavorable audience reaction.

14. The method of claim 1, comprising:
extracting presenter video data from the video data of the presentation digital data;
analyzing the presenter video data to identify a characteristic of the presenter video data; and
identifying the portions of the presentation digital data based on changes in the characteristic of the presenter video data.

15. The method of claim 14, wherein the characteristic of the presenter video data comprises at least one of a motion characteristic and an expression characteristic related to the present as depicted within the presenter video data.

16. The method of claim 1, wherein the identified portions of the presentation digital data comprise secondary content related to primary content, and the method comprises:
causing presentation of a graphical user interface (GUI) on a display screen, the GUI depicting the primary content;
causing presentation within the GUI of an indicator corresponding to a portion of the primary content, the indicator indicating availability of related secondary content of the secondary content, related to the portion of the primary content;
detecting user selection of the indicator;
responsive to the detection of the user selection of the indicator, causing presentation within the GUI of a plurality of secondary content identifiers that are user selectable to access the related secondary content, related to the portion of the primary content.

17. The method of claim 16, wherein metadata is presented within the GUI in association with the plurality of second content identifiers to enable a user to filter the plurality of secondary content identifiers based on the metadata.

18. The method of claim 17, wherein the metadata comprises the associated tags.

19. A computing apparatus comprising:
at least one processor; and
at least one memory storing instructions that, when executed by the at least one processor, configure the apparatus to:
extract speaker audio data from audio data of presentation digital data;
analyze the speaker audio data to identify a characteristic of the speaker audio data, the characteristic including at least one of tone, frequency, cadence, and volume of a speaker;
identify portions of the presentation digital data based on changes in the characteristic of the speaker audio data;
automatically generate tags for the identified portions of the presentation digital data based on the characteristic of the speaker audio data; and
store the identified portions of the presentation digital data and associated tags for retrieval.

20. A non-transitory computer-readable storage medium, the computer-readable storage medium including instructions that when executed by at least one computer, cause the at least one computer to:
extract speaker audio data from audio data of presentation digital data;
analyze the speaker audio data to identify a characteristic of the speaker audio data, the characteristic including at least one of tone, frequency, cadence, and volume of a speaker;
identify portions of the presentation digital data based on changes in the characteristic of the speaker audio data;
automatically generate tags for the identified portions of the presentation digital data based on the characteristic of the speaker audio data; and
store the identified portions of the presentation digital data and associated tags for retrieval.
